(19) United States
(12) Patent Application Publication
(10) Pub. No.: US 2026/0063780 A1
(43) Pub. Date: Mar. 5, 2026

(54) FREQUENCY MODULATED CONTINUOUS WAVE SYNCRHONIZATION SIGNAL DESIGN

(71) Applicant: QUALCOMM Incorporated, San Diego, CA (US)

(72) Inventors: Kangqi LIU, San Diego, CA (US); Jing SUN, San Diego, CA (US); Weimin DUAN, San Diego, CA (US); Jing JIANG, San Diego, CA (US)

(21) Appl. No.: 18/823,210

(22) Filed: Sep. 3, 2024

(51) Int. Cl. G01S 13/34; G01S 7/35

(52) U.S. Cl. CPC G01S 13/343; G01S 7/352

(57) ABSTRACT

Aspects relate to an FMCW waveform design for synchronization signals in which two FMCW signals with opposite direction slopes are concatenated in time. For example, a first FMCW signal with a linearly decreasing slope can be concatenated in time with a second FMCW signal with a linearly increasing slope. The resulting V-shaped or inverse V-shaped FMCW waveform may be utilized for transmission of a synchronization signal, such as a primary synchronization signal (PSS) or other light synchronization signal block (SSB) signal.

### TECHNICAL FIELD

The technology discussed below relates generally to wireless communication networks, and more particularly, to synchronization signal designs in wireless communication networks.

### INTRODUCTION

In wireless communication systems, such as those specified under standards for 5G New Radio (NR), 6G, and other standards, a network entity (e.g., a base station) may communicate with a user equipment (UE) (e.g., a smartphone) within a cell. The network entity may broadcast synchronization signal blocks (SSBs) in the cell at regular intervals based on a configured periodicity (e.g., 20 ms). A number of SSBs, referred to as an SSB burst set, are typically transmitted in different directions (e.g., on different beams) during a five millisecond (ms) SSB burst time period. For example, in milli-meter wave systems (e.g., FR2 systems), up to sixty-four SSBs may be transmitted in an SSB burst.

An SSB includes a primary synchronization signal (PSS), a secondary synchronization signal (SSS), and a physical broadcast control channel (PBCH). From the PSS and SSS, radio frame, subframe, slot, and symbol synchronization may be achieved in the cell in the time domain. In addition, the PSS and SSS collectively identify the physical cell identity (PCI) of the cell. The PBCH in the SSB may further include a master information block (MIB) that defines various system information, along with parameters for decoding a system information block (SIB). The SIB may be, for example, a SystemInformationType 1 (SIB1) that may include various remaining minimum system information (RMSI) for initial access.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, an apparatus operable at a user equipment (UE) is provided. The apparatus includes one or more memories and one or more processors coupled to the one or more memories. The one or more processors are configured to obtain a synchronization signal including a frequency modulated continuous wave (FMCW) waveform. The FMCW waveform concatenates in time a first FMCW signal including a linearly decreasing slope with a second FMCW signal including a linearly increasing slope. The one or more processors are further configured to perform frequency and time estimation based on the FMCW waveform.

Another example provides a method operable at a user equipment (UE). The method includes obtaining a synchronization signal including a frequency modulated continuous wave (FMCW) waveform. The FMCW waveform concatenates in time a first FMCW signal including a linearly decreasing slope with a second FMCW signal including a linearly increasing slope. The method further includes performing frequency and time estimation based on the FMCW waveform.

Another example provides an apparatus operable at a network entity. The apparatus includes one or more memories and one or more processors coupled to the one or more memories. The one or more processors are configured to provide a first frequency modulated continuous wave (FMCW) signal including a linearly increasing slope and provide a second FMCW signal including a linearly decreasing slope. The first FMCW signal is concatenated in time with the second FMCW signal to produce a frequency modulated continuous wave (FMCW) waveform including a synchronization signal.

Another example provides a method operable at a network entity. The method includes providing a first frequency modulated continuous wave (FMCW) signal including a linearly increasing slope and providing a second FMCW signal including a linearly decreasing slope. The first FMCW signal is concatenated in time with the second FMCW signal to produce a frequency modulated continuous wave (FMCW) waveform including a synchronization signal.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a diagram illustrating an example of a wireless communication system and an access network according to some aspects.

FIG. 2 is a diagram providing a high-level illustration of one example of a configuration of a disaggregated base station according to some aspects.

FIGS. 3A, 3B, 3C, and 3D are diagrams illustrating examples of a first 5G/NR frame, DL channels within a 5G/NR subframe, a second 5G/NR frame, and UL channels within a 5G/NR subframe, respectively.

FIG. 4 is a diagram illustrating various system information related to cell access that may be broadcast in a cell according to some aspects.

FIG. 5 is a diagram illustrating an exemplary system information transmission mechanism according to some aspects.

FIG. 6 is a diagram illustrating an example of communication using FMCW waveforms according to some aspects.

FIGS. 7A and 7B are diagrams depicting an example ambiguity in processing FMCW-based synchronization signals.

FIG. 8 is a diagram illustrating an example of an X-shaped FMCW-based synchronization signal design.

FIG. 9 is a diagram illustrating an example of a V-shaped FMCW-based synchronization signal design.

FIGS. 10A and 10B are diagrams illustrating search windows for V-shaped FMCW synchronization signals according to some aspects.

FIGS. 11A and 11B are diagrams illustrating examples of receiver architectures for V-shaped FMCW-based PSS detection according to some aspects.

FIGS. 12A and 12B are diagrams illustrating other examples of receiver architectures for V-shaped FMCW-based PSS detection according to some aspects.

FIGS. 13A and 13B are diagrams illustrating other examples of receiver architectures for V-shaped FMCW-based PSS detection according to some aspects.

FIG. 14 is a diagram illustrating examples of multi-cell differentiation according to some aspects.

FIG. 15 is a block diagram illustrating an example of a hardware implementation for UE employing a processing system according to some aspects.

FIG. 16 is a flow chart of an exemplary process for receiving an FMCW-based synchronization signal according to some aspects.

FIG. 17 is a block diagram illustrating an example of a hardware implementation for a network entity employing a processing system according to some aspects.

FIG. 18 is a flow chart of an exemplary process for providing an FMCW-based synchronization signal according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

Periodic transmission of SSBs consumes a significant amount of energy at the network entity. Therefore, a simple downlink reference signal, referred to herein as a light SSB (e.g., only a PSS), may be transmitted frequently to facilitate UE initial cell search, followed by less frequent actual SSB (or modified SSBs without the PSS) transmissions. When a UE detects the light SSB, the UE is aware of the cell deployment and can stay on the synchronization (sync) raster longer to look for the actual SSB. Frequency modulated continuous wave (FMCW) waveforms have been proposed for the light SSB. By using an FMCW-based light SSB (PSS) waveform, the UE can scan multiple sync raster points at a time, with relatively low complexity. However, FMCW waveforms may suffer from potential time and frequency offset ambiguity. For example, in some cases, a frequency offset (e.g., due to oscillator offset) and timing offset may not be distinguishable at the PSS detector output at the receiver.

Various aspects are related to an FMCW waveform design for synchronization signals (e.g., PSSs) in which two FMCW signals with opposite direction slopes are concatenated in time. For example, a first FMCW signal with a linearly decreasing slope can be concatenated in time with a second FMCW signal with a linearly increasing slope. The resulting V-shaped FMCW-based PSS design reduces the time/frequency offset ambiguity, maintains a low (0 dB) peak-to-average-power ratio (PAPR), and maintains a high signal-to-noise ratio (SNR) for each of the first and second FMCW signals.

Each of the first FMCW signal and the second FMCW signal may have the same duration or different durations. For example, one of the FMCW signals may have a duration equal to integer multiple or integer fraction of the duration of the other FMCW signal. In some examples, the first and second FMCW signals may have the same absolute slope value (with opposite slope signs). In other examples, the first and second FMCW signals may have different absolute slope values (with opposite slope signs). In some examples, a concatenation order and/or respective slope of the first and second FMCW signals may indicate an identifier of the PSS. As such, the FMCW-based PSS design may further facilitate multiple neighboring cell differentiation.

In some examples, a receiving device (e.g., a receiver at the UE) may apply a first locally generated FMCW signal (e.g., an up-sweep FMCW signal or a down-sweep FMCW signal) to the received FMCW waveform during one or more first search windows to detect a beat frequency between the first locally generated FMCW signal and the FMCW waveform. Upon detecting the beat frequency, the receiving device may then apply a second locally generated FMCW signal having the opposite direction sweep than the first locally generated FMCW signal to the FMCW waveform during one or more additional search windows to detect an additional beat frequency. The receiving device may then perform frequency and time estimation (e.g., determining the frequency and time offset) based on the detected beat frequencies.

In some examples, a receiving device (e.g., a receiver at the UE) may include two signal paths, one for each of the first and second FMCW signals. A switch may be configured along one of the signal paths to turn on and off the FMCW signal to that signal path. For example, the receiver may combine the first locally generated FMCW signal with the FMCW waveform in the analog or digital domain along a first signal path. Upon detecting the beat frequency along the first signal path, the receiver may turn on the switch to combine the second locally generated FMCW signal with the FMCW waveform along a second signal path. In some examples, each of the signal paths has a respective switch that can be turned on or off based on the FMCW signal being detected (e.g., either the first (down) FMCW signal or the second (up) FMCW signal). In some examples, a single signal path is used and a switch is configured to switch between the first locally generated FMCW signal and the second locally generated FMCW signal.

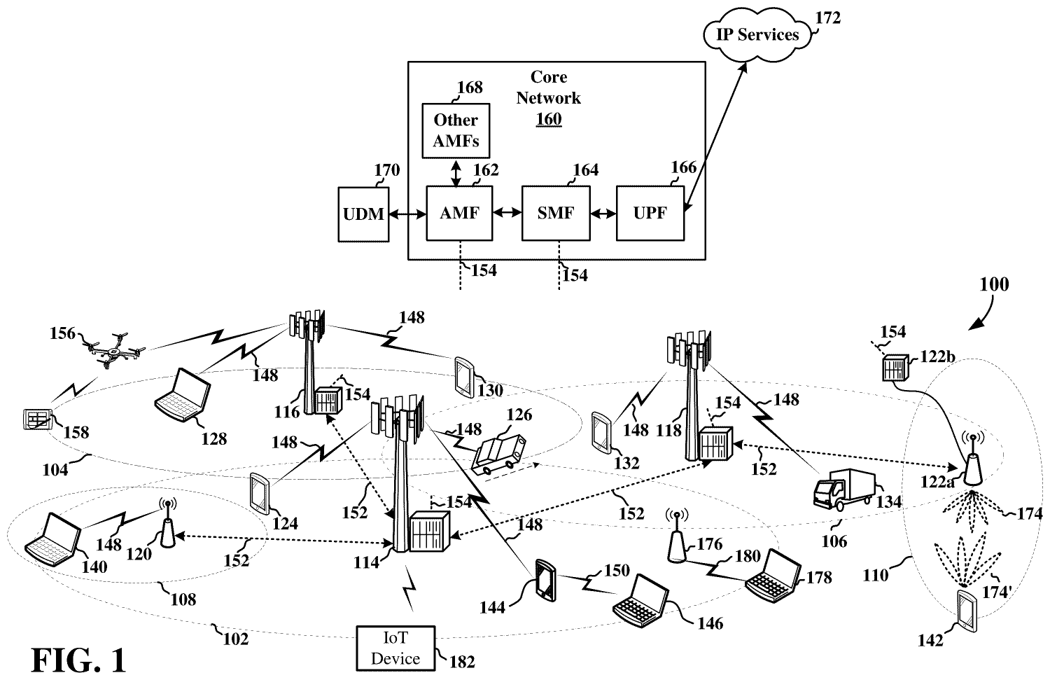

The various concepts presented throughout this disclosure may be implemented across a broad variety of telecommunication systems, network architectures, and communication standards. Referring now to FIG. 1, as an illustrative example without limitation, a schematic illustration of a wireless communication network including a radio access network (RAN) 100 and a core network 160 is provided. The RAN 100 may implement any suitable wireless communication technology or technologies to provide radio access. As one example, the RAN 100 may operate according to 3rd Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. In other examples, the RAN 100 may operate according to a hybrid of 5G NR and 6G, may operate according to 6G, or may operate according to other future radio access technology (RAT). Of course, many other examples may be utilized within the scope of the present disclosure.

The geographic region covered by the RAN 100 may be divided into a number of cellular regions (cells) that can be uniquely identified by a user equipment (UE) based on an identification broadcasted over a geographical area from one access point or network entity. FIG. 1 illustrates cells 102, 104, 106, 108, and 110 each of which may include one or more sectors (not shown). A sector is a sub-area of a cell. All sectors within one cell are served by the same network entity. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is responsible for radio transmission and reception in one or more cells to or from a UE. A network entity may also be referred to by those skilled in the art as a base station (e.g., an aggregated base station or disaggregated base station), base transceiver station (BTS), a radio base station, a radio transceiver, a transceiver function, a basic service set (BSS), an extended service set (ESS), an access point (AP), a Node B (NB), an evolved NB (eNB), a 5G NB (gNB), a transmission receive point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the network entities may be an LTE network entity, while another network entity may be a 5G NR network entity.

In some examples, the RAN 100 may employ an open RAN (O-RAN) to provide a standardization of radio interfaces to procure interoperability between component radio equipment. For example, in an O-RAN, the RAN may be disaggregated into a centralized unit (CU), a distributed unit (DU), and a radio unit (RU). The RU is configured to transmit and/or receive (RF) signals to and/or from one or more UEs. The RU may be located at, near, or integrated with, an antenna. The DU and the CU provide computational functions and may facilitate the transmission of digitized radio signals within the RAN 100. In some examples, the DU may be physically located at or near the RU. In some examples, the CU may be located near the core network 160.

The DU provides downlink and uplink baseband processing, a supply system synchronization clock, signal processing, and an interface with the CU. The RU provides downlink baseband signal conversion to an RF signal, and uplink RF signal conversion to a baseband signal. The O-RAN may include an open fronthaul (FH) interface between the DU and the RU. Aspects of the disclosure may be applicable to an aggregated RAN and/or to a disaggregated RAN (e.g., an O-RAN).

Various network entity arrangements can be utilized. For example, in FIG. 1, network entities 114, 116, and 118 are shown in cells 102, 104, and 106; and another network entity 122 is shown controlling a remote radio head (RRH) 122 in cell 110. That is, a network entity can have an integrated antenna or can be connected to an antenna or RRH by feeder cables. In the illustrated example, the cells 102, 104, 106, and 110 may be referred to as macrocells, as the network entities 114, 116, 118, and 122 support cells having a large size. Further, a network entity 120 is shown in the cell 108 which may overlap with one or more macrocells. In this example, the cell 108 may be referred to as a small cell (e.g., a microcell, picocell, femtocell, home base station, home Node B, home eNode B, etc.), as the network entity 120 supports a cell having a relatively small size. Cell sizing can be done according to system design as well as component constraints.

It is to be understood that the RAN 100 may include any number of network entities and cells. Further, a relay node may be deployed to extend the size or coverage area of a given cell. In some examples, a cell may not necessarily be stationary, and the geographic area of the cell may move according to the location of a mobile network entity.

FIG. 1 further includes an unmanned aerial vehicle (UAV) 156, which may be a drone or quadcopter. The UAV 156 may be configured to function as a network entity, or more specifically as a mobile network entity. That is, in some examples, a cell may not necessarily be stationary, and the geographic area of the cell may move according to the location of a mobile network entity such as the UAV 156.

In addition to other functions, the network entities 114, 116, 118, 120, and 122a/122b may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The network entities 114, 116, 118, 120, and 122a/122b may communicate directly or indirectly (e.g., through the core network 170) with each other over backhaul links 152 (e.g., X2 interface). The backhaul links 152 may be wired or wireless.

The RAN 100 is illustrated supporting wireless communication for multiple mobile apparatuses. A mobile apparatus is commonly referred to as user equipment (UE) in standards and specifications promulgated by the 3rd Generation Partnership Project (3GPP), but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move, and may be stationary. The term mobile apparatus or mobile device broadly refers to a diverse array of devices and technologies. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 124, 126, and 144 may be in communication with network entity 114; UEs 128 and 130 may be in communication with network entity 116; UEs 132 and 138 may be in communication with network entity 118; UE 140 may be in communication with network entity 120; UE 142 may be in communication with network entity 122a via RRH 122b; and UE 158 may be in communication with mobile network entity 156. Here, each network entity 114, 116, 118, 120, 122a/122b, and 156 may be configured to provide an access point to the core network 170 (not shown) for all the UEs in the respective cells. In another example, a mobile network node (e.g., UAV 156) may be configured to function as a UE. For example, the UAV 156 may operate within cell 104 by communicating with network entity 116. UEs may be located anywhere within a serving cell. UEs that are located closer to a center of a cell (e.g., UE 132) may be referred to as cell center UEs, whereas UEs that are located closer to an edge of a cell (e.g., UE 134) may be referred to as cell edge UEs. Cell center UEs may have a higher signal quality (e.g., a higher reference signal received power (RSRP) or signal-to interference-plus-noise ratio (SINR)) than cell edge UEs.

In the RAN 100, the ability for a UE to communicate while moving, independent of their location, is referred to as mobility. The various physical channels between the UE and the RAN are generally set up, maintained, and released under the control of an access and mobility management function (AMF), which may include a security context management function (SCMF) that manages the security context for both the control plane and the user plane functionality and a security anchor function (SEAF) that performs authentication. In some examples, during a call facilitated by a network entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE May undertake a handoff or handover from the serving cell to the neighboring (target) cell. For example, UE 126 may move from the geographic area corresponding to its serving cell 102 to the geographic area corresponding to a neighbor cell 106. When the signal strength or quality from the neighbor cell 106 exceeds that of its serving cell 102 for a given amount of time, the UE 126 may transmit a reporting message to its serving network entity 114 indicating this condition. In response, the UE 126 may receive a handover command, and the UE may undergo a handover to the cell 106.

Wireless communication between a RAN 100 and a UE (e.g., UE 124, 126, or 144) may be described as utilizing communication links 148 over an air interface. Transmissions over the communication links 148 between the network entities and the UEs may include uplink (UL) (also referred to as reverse link) transmissions from a UE to a network entity and/or downlink (DL) (also referred to as forward link) transmissions from a network entity to a UE. For example, DL transmissions may include unicast or broadcast transmissions of control information and/or data (e.g., user data traffic or other type of traffic) from a network entity (e.g., network entity 114) to one or more UEs (e.g., UEs 124, 126, and 144), while UL transmissions may include transmissions of control information and/or traffic information originating at a UE (e.g., UE 124). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The communication links 148 may use multiple-input and multiple-output (MIMO) antenna technology, including spatial multiplexing, beamforming, and/or transmit diversity. For example, as shown in FIG. 1, network entity 122a/122b may transmit a beamformed signal to the UE 142 via one or more beams 174 in one or more transmit directions. The UE 142 may further receive the beamformed signal from the network entity 122a/122b via one or more beams 174′ in one or more receive directions. The UE 142 may also transmit a beamformed signal to the network entity 122a/122b via the one or more beams 174′ in one or more transmit directions. The network entity 122a/122b may further receive the beamformed signal from the UE 142 via the one or more beams 174 in one or more receive directions. The network entity 122a/122b and the UE 142 may perform beam training to determine the best transmit and receive beams 174/174′ for communication between the network entity 122a/122b and the UE 142. The transmit and receive beams for the network entity 122a/122b may or may not be the same. The transmit and receive directions for the UE 142 may or may not be the same.

The communication links 148 may utilize one or more carriers. The network entities and UEs may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The communication links 148 in the RAN 100 may further utilize one or more multiplexing and multiple access algorithms to enable simultaneous communication of the various devices. For example, 5G NR specifications provide multiple access for UL or reverse link transmissions from UEs 124, 126, and 144 to network entity 114, and for multiplexing DL or forward link transmissions from the network entity 114 to UEs 124, 126, and 144 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the network entity 114 to UEs 124, 126, and 144 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the communication links 148 in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the communication links 148 in the RAN 100 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

In some examples, access to the air interface may be scheduled, wherein a scheduling entity (e.g., a network entity 114) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs (e.g., UE 124), which may be scheduled entities, may utilize resources allocated by the scheduling entity 114.

Network entities are not the only entities that may function as scheduling entities. That is, in some examples, a UE may function as a scheduling entity, scheduling resources for one or more scheduled entities (e.g., one or more other UEs). For example, two or more UEs (e.g., UEs 144 and 146) may communicate with each other using peer to peer (P2P) or sidelink signals via a sidelink 150 therebetween without relaying that communication through a network entity (e.g., network entity 114). In some examples, the UEs 144 and 146 may each function as a scheduling entity or transmitting sidelink device and/or a scheduled entity or a receiving sidelink device to communicate sidelink signals therebetween without relying on scheduling or control information from a network entity (e.g., network entity 114). In other examples, the network entity 114 may allocate resources to the UEs 144 and 146 for sidelink communication. For example, the UEs 144 and 146 may communicate using sidelink signaling in a P2P network, a device-to-device (D2D) network, vehicle-to-vehicle (V2V) network, a vehicle-to-everything (V2X), a mesh network, or other suitable network.

In some examples, a D2D relay framework may be included within a cellular network to facilitate relaying of communication to/from the network entity 114 via D2D links (e.g., sidelink 150). For example, one or more UEs (e.g., UE 144) within the coverage area of the network entity 114 may operate as a relaying UE to extend the coverage of the network entity 114, improve the transmission reliability to one or more UEs (e.g., UE 146), and/or to allow the network entity to recover from a failed UE link due to, for example, blockage or fading.

The wireless communications system may further include a Wi-Fi access point (AP) 176 in communication with Wi-Fi stations (STAs) 178 via communication links 180 in a 5 GHz unlicensed frequency spectrum. When communicating in an unlicensed frequency spectrum, the STAs 170/AP 176 may perform a clear channel assessment (CCA) prior to communicating in order to determine whether the channel is available.

In some examples, a UE may correspond to an IoT device 182. The IoT device 182 may include, for example, a passive IoT device, such as RFID-type sensor/actuator (SA), a semi-passive IoT device, or an active IoT device. Active IoT devices and semi-active IoT device may include a battery or power source that may be charged, for example, using wireless power transfer (WPT) or, more generally, ambient energy harvesting, whereas passive IoT devices lack an internal power source, and therefore, use ambient energy harvesting to power the device. Semi-passive IoT devices may include a capacitor or other storage device that provides a warm start-up to the energy harvesting in the device. The IoT device 182 may communicate with a network entity (e.g., network entity 114 or RFID reader). In some examples, the network entity 114 may communicate with the IoT device via cellular (Uu) links. For example, the network entity 114 may provide an energy transmission on the downlink to power the IoT device. The energy transmission may further be modulated and backscattered by the IoT device 182 as an information-bearing signal on the uplink. In addition, the network entity 114 may transmit control information and/or data to the IoT device 182 on the downlink, which may be detected by the IoT device using, for example, envelope detection. In this manner, the network entity 114 may read information from the IoT device 182 and write information to the IoT device 182.

The network entities 114, 116, 118, 120, and 122a/122b provide wireless access points to the core network 160 for any number of UEs or other mobile apparatuses via core network backhaul links 154. The core network backhaul links 154 may provide a connection between the network entities 114, 116, 118, 120, and 122a/122b and the core network 170. In some examples, the core network backhaul links 154 may include backhaul links 152 that provide interconnection between the respective network entities. The core network may be part of the wireless communication system and may be independent of the radio access technology used in the RAN 100. Various types of backhaul interfaces may be employed, such as a direct physical connection (wired or wireless), a virtual network, or the like using any suitable transport network.

The core network 160 may include an Access and Mobility Management Function (AMF) 162, other AMFs 168, a Session Management Function (SMF) 164, and a User Plane Function (UPF) 166. The AMF 162 may be in communication with a Unified Data Management (UDM) 170. The AMF 162 is the control node that processes the signaling between the UEs and the core network 160. Generally, the AMF 162 provides QoS flow and session management. All user Internet protocol (IP) packets are transferred through the UPF 166. The UPF 166 provides UE IP address allocation as well as other functions. The UPF 166 is configured to couple to IP Services 172. The IP Services 172 may include the Internet, an intranet, an IP Multimedia Subsystem (IMS), a PS Streaming Service, and/or other IP services.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (cNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

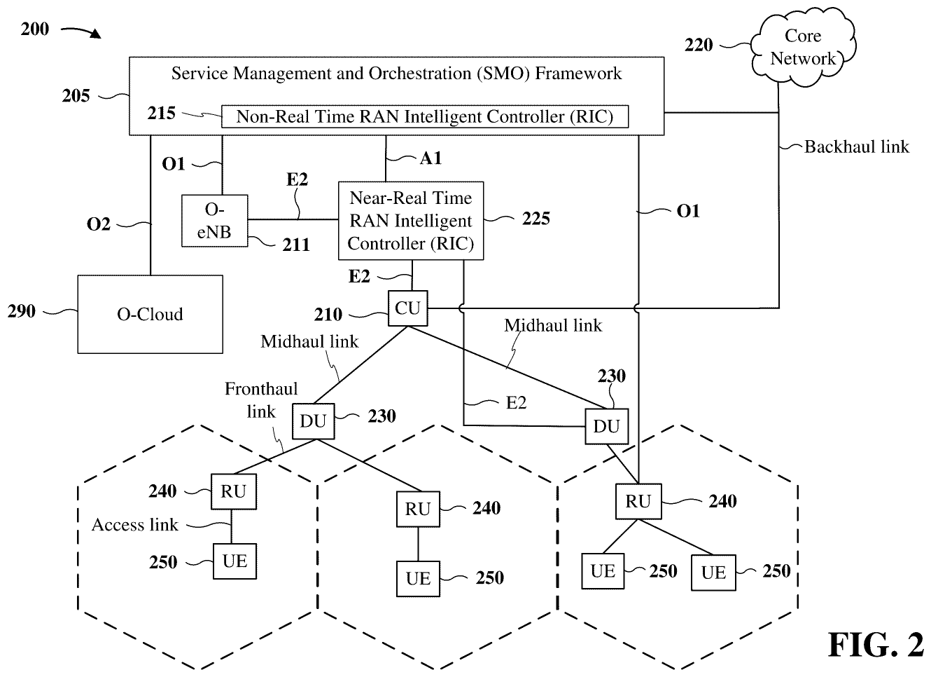

FIG. 2 shows a diagram illustrating an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 250 via one or more radio frequency (RF) access links. In some implementations, the UE 250 may be simultaneously served by multiple RUs 240.

Each of the units, i.e., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 2rd Generation Partnership Project (2GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 250. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 5G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

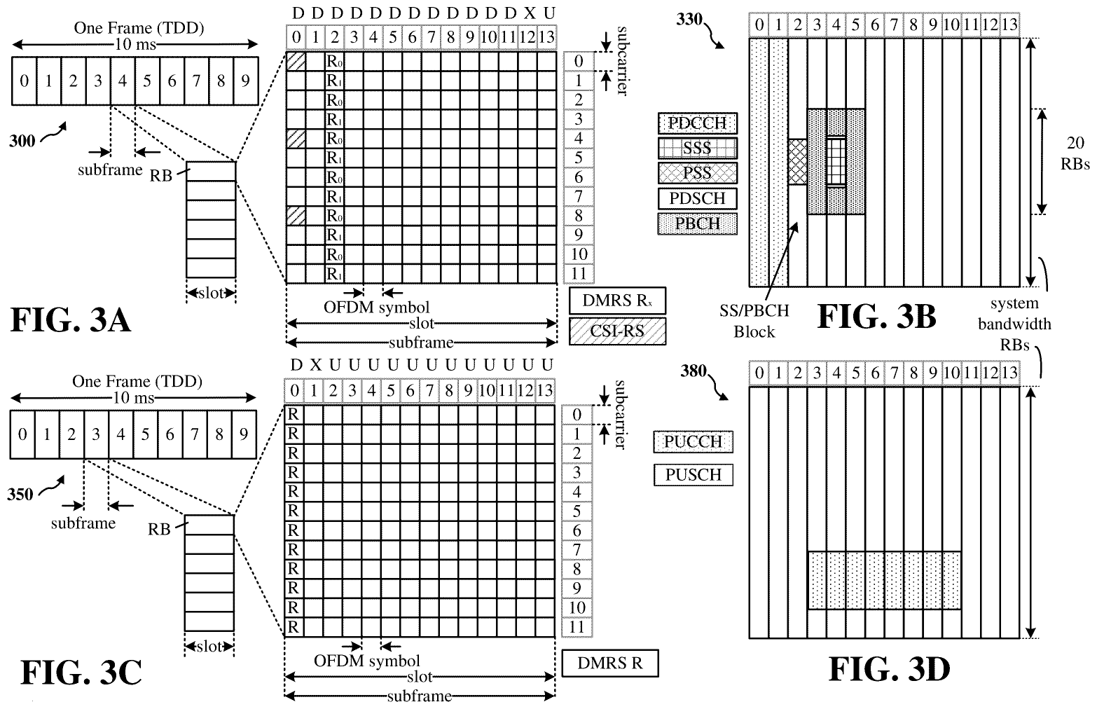

FIG. 3A is a diagram 300 illustrating an example of a first subframe within a 5G/NR frame structure. FIG. 3B is a diagram 330 illustrating an example of DL channels within a 5G/NR subframe. FIG. 3C is a diagram 350 illustrating an example of a second subframe within a 5G/NR frame structure. FIG. 3D is a diagram 380 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 3A, 3C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kKz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) ACK/NACK feedback. The PUSCH carries data, and may additionally be used to carry a buffer status report (BSR), a power headroom report (PHR), and/or UCI.

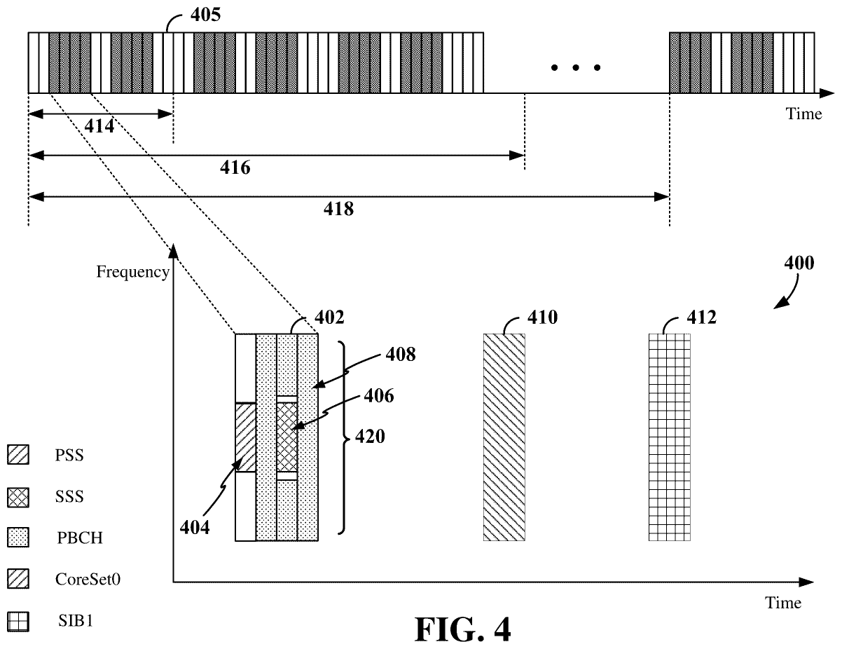

FIG. 4 is a diagram illustrating various system information related to cell access that may be broadcast in a cell according to some aspects. The system information (SI) 400 may include, for example, an SSB 402, a control resource set 0 (CORESET0) 410, and a SIB1 412. The SSB 402 may be broadcast, for example, over four OFDM symbols 405 of a slot 414 in the time domain and over a number of PRBs 420 (e.g., 20 PRBs) in the frequency domain. In addition, the SSB 402 may have a periodicity 418 of, for example, 20 ms or other suitable periodicity.

The SSB 402 may include a PSS 404, a SSS 406, and a PBCH 408. The PSS 404 may be transmitted in the first OFDM symbol of the SSB and may occupy, for example, 127 subcarriers in the frequency domain. The remaining subcarriers within the total SSB PRBs 420 in the first OFDM symbol are empty. The SSS 406 is transmitted in the third OFDM symbol of the SSB and occupies the same set of 127 subcarriers as the PSS. The PBCH 408 is transmitted on the second and fourth OFDM symbols of the SSB and occupies the entire number of PRBs (e.g., 20 PRBs) 420 of the SSB. In addition, the PBCH 408 is further transmitted on the third OFDM symbol and occupies 48 subcarriers on either side of the SSS. Respective sets of empty subcarriers on either side of the SSS 406 separate the SSS 406 and PBCH 408 on the third OFDM symbol.

The PSS 404, SSS 406, and PBCH 408 enable a UE to identify a cell and synchronize with the timing of the cell. For example, the PSS 404 may include a PSS sequence selected from a set of PSS sequences, such as maximum length sequences (m-sequences). In addition, the SSS 406 may include a SSS sequence selected from a set of SSS sequences, such as m-sequences. For example, the PSS sequence for an SSB may be selected from one of three M-sequences, each having a sequence length of 127, determined from a set of PSS defined shifts

$${N}_{ID}^{( 2 )} ∈ \{ 0 , 1 , 2 \} ,$$

while the SSS sequence for an SSB may be selected from one of 334 M-sequences, each having a sequence length of 127, determined from a set of SSS defined shifts

$${N}_{ID}^{( 1 )} ∈ \{ 0 , … , 335 \} .$$

In some examples, the PSS/SSS sequences identify the PCI (e.g., the PCI of the cell within which the SSB 402 is transmitted). For example, the

$$PCI ( {N}_{ID}^{Cell} )$$

may be defined by

$${N}_{ID}^{Cell} = 3 {N}_{ID}^{( 1 )} + {N}_{ID}^{( 2 )} ,$$

where

$${N}_{ID}^{( 1 )}$$

is the SSS range from 0 to 335 and

$${N}_{ID}^{( 2 )}$$

is the PSS range from 0 to 2. By successfully demodulating the PSS, the value

$${N}_{ID}^{( 2 )}$$

may be obtained. The SSS may then be demodulated and combined with knowledge of

$${N}_{ID}^{( 2 )}$$

to obtain

$${N}_{ID}^{( 1 )} .$$

The PBCH 408 includes the MIB carrying various system information such as, for example, an SSB time index identifying the SSB location within an SSB burst set, a cell barred indication, the subcarrier spacing, the first PDSCH DMRS position, the system frame number, and scheduling information for the CORESET0 410. For example, the PBCH 408 may include a search space for the COERSET0 410. In some examples, the CORESET0 410 may carry a PDCCH with DCI that contains scheduling information for scheduling the SIB1 412. The SIB1 412 is carried within a physical downlink shared channel (PDSCH) within a data region of a slot 414. In addition, the SIB1 412 contains remaining minimum system information (RMSI), including, for example, a set of radio resource parameters providing network identification and configuration. For example, the set of radio resource parameters may include a bandwidth (e.g., number of BWPs) on which a UE may communicate with the network entity and a set of RACH occasions on which the UE may initiate an initial access procedure (e.g., a RACH procedure). The UE may use the RACH procedure to request other system information (OSI), for example, SIB2 to SIB9.

The SSB 402 may be transmitted in a beam-sweeping manner. For example, L SSB beams in different beam directions may be time-multiplexed into an SSB burst set (also referred to herein as an SSB burst), where L equals 4, 8, or 44. The SSB burst set is transmitted within an SSB burst time period 416. The SSB burst time period 416 may correspond, for example, to 5 ms. The SSB burst set is further transmitted with the SSB periodicity 418. For example, the SSB burst set may be transmitted within a 5 ms time period 418 every 20 ms. In some examples, the SSB burst set may be transmitted within either the first half or second half of a 10 ms frame.

Periodic transmission of the SSB consumes a significant amount of energy at the network entity. If there are no or very few UEs within a cell, the cell may expend energy unnecessarily by periodically sending SSBs in all directions. Therefore, in various aspects of the disclosure, the network entity may transmit a simple downlink reference signal, referred to herein as a light SSB, more frequently to facilitate UE initial cell search. When the UE detects the light SSB, the UE may stay on the synchronization raster (sync raster) frequency to look for the SSB. In some examples, the light SSB may include only the PSS.

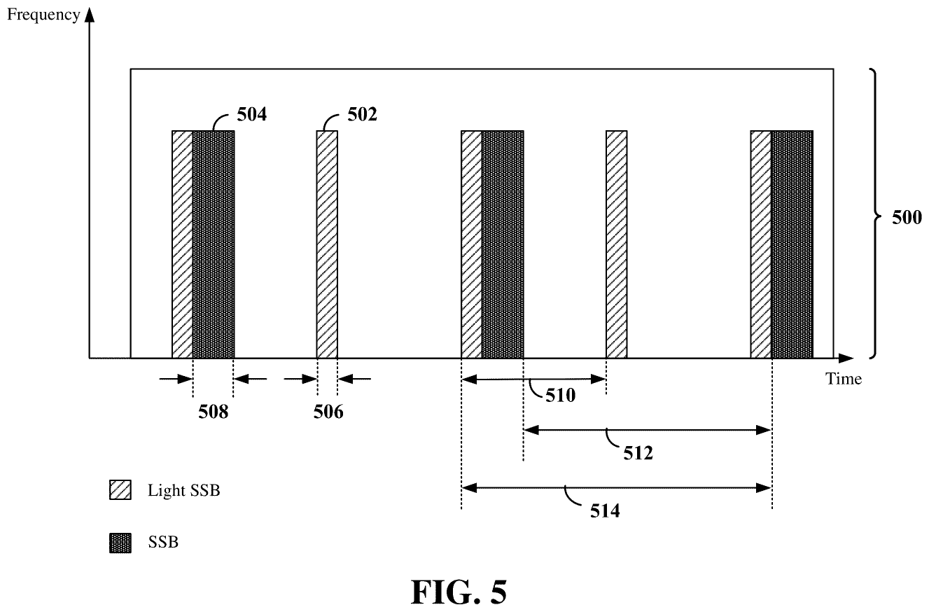

FIG. 5 is a diagram illustrating an exemplary system information transmission mechanism according to some aspects. In the example shown in FIG. 5, a light SSB or other discovery signal 502 may be transmitted with a light SSB periodicity 510 (e.g., 20 ms or other suitable periodicity). In addition, an SSB 504 may be transmitted with an SSB periodicity 512 (e.g., 80 or 160 ms). The light SSB periodicity 510 may be configured, for example, with a periodicity of P1, and the SSB periodicity 512 may be configured with a periodicity of k*P1, where k>1. In some examples, the light SSB may include only the PSS. In this example, the SSB may include only the SSS and PBCH.

In some examples, the light SSB 502 and the SSBs 504 may be transmitted within a same bandwidth part 500. In addition, the light SSB 502 and the SSBs 504 may be transmitted on the same set of frequency resources (e.g., same/identical PRBs) or on overlapping sets of resources (e.g., overlapping PRBs) within the same bandwidth part 500, the former being illustrated.

In some examples, the light SSB 502 may be transmitted as a light SSB burst (e.g., as a plurality of light SSBs in different beam directions) within a light SSB burst time period 506. The light SSB burst may further be transmitted with the light SSB periodicity 510. In addition, the SSB 504 may be transmitted as an SSB burst within an SSB burst time period 508.

In this example, as shown in FIG. 5, there may be a many-to-one mapping from the light SSB burst 502 to the SSB burst 504. For example, the network entity may transmit a plurality of light SSB bursts 502 within the SSB period 512. In this example, each of the light SSB bursts 502 may include a light SSB burst index within the SSB period 512. For example, if the SSB period 512 is 40 ms and light SSB period 510 is 20 ms, the light SSB burst index may be either 0 or 1 (e.g., there are two light SSB bursts sent within the SSB period 512). Including the light SSB burst index in each light SSB 502 can simplify the UE search for SSBs in examples in which the location of an SSB within an SSB period 512 is known. In other examples, each of the light SSB bursts 502 may include a burst offset 514 to a next SSB burst 504. In examples in which the light SSB 502 is not transmitted as a light SSB burst, the light SSB 502 may include a symbol or slot offset to the corresponding SSB (or SSB burst) 504.

In 5G+/6G wireless communication systems, the light SSB may be transmitted using a frequency modulated continuous wave (FMCW) waveform. Such an FMCW waveform may further be used to estimate the OFDM channel. For example, by using an FMCW waveform, all signal processing for the OFDM channel estimation may be performed in the time domain, and the frequency domain channel may then be estimated from the time domain channel. An FMCW waveform is a signal where the frequency increases linearly with time (referred to as an up-chirp) or decreases linearly with time (referred to as a down-chirp). In FMCW, a difference between the transmitted signal carrier frequency and the received signal carrier frequency is referred to as a beat frequency.

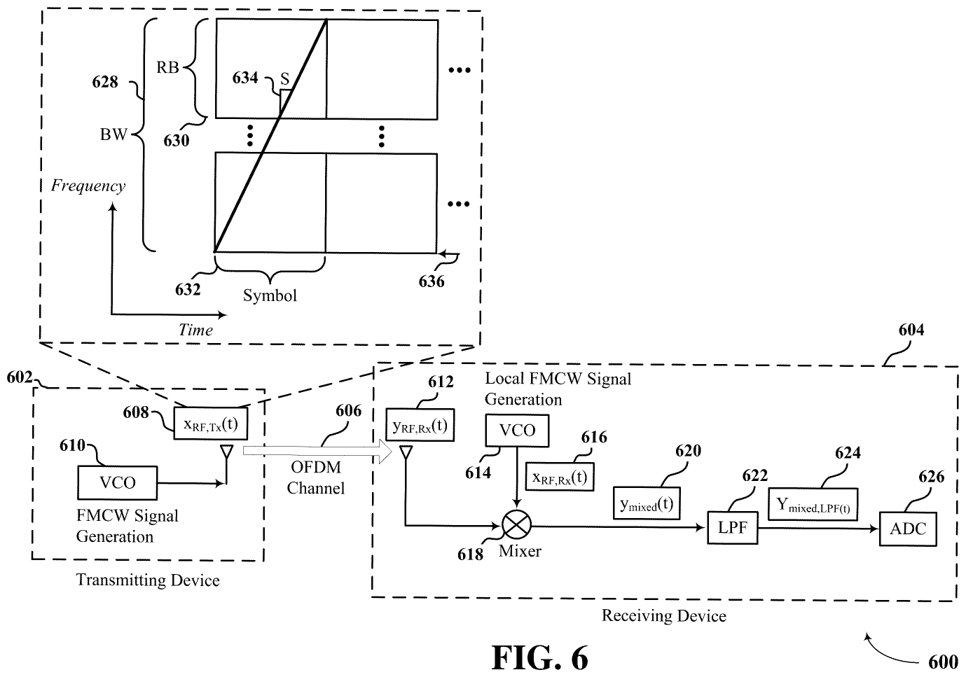

FIG. 6 is a diagram illustrating an example of communication using FMCW waveforms according to some aspects. In this example, a transmitting device 602 (e.g., a UE or a network entity (e.g., an aggregated base station, an RU, a DU, a CU, an integrated access backhaul (IAB) node or other network device)) and a receiving device 604 (e.g., a UE or a network entity (e.g., an aggregated base station, an RU, a DU, a CU, an integrated access backhaul (IAB) node or other network device)) may exchange an FMCW signal via an OFDM channel 606. In some examples, the receiving device 604 may estimate the wireless channel 606 using time domain signal processing of the FMCW signal.

The transmitting device 602 may generate an FMCW signal 608 (e.g., a first FMCW signal). In some examples, the transmitting device 602 may generate the FMCW signal 608 in an analog domain using a voltage controlled oscillator (VCO) 610. The transmitting device 602 may transmit the FMCW signal 608 via the OFDM channel 606 using at least one antenna element at the transmitting device 602. The analog domain FMCW signal 608 generated and transmitted by the transmitting device 602 may be represented by x_(RF,Tx) (t), shown in Equation 1.

$${x}_{R , F , Tx} ( t ) = cos ( 2 π ( {f}_{c} + \frac{s}{2} t ) t + {ϕ}_{Tx} \qquad ( Equation 1 )$$

As shown in Equation 1, the FMCW signal 608 may be a time-domain signal (e.g., a function of time (t)). In the example of Equation 1, f_{c} may represent a starting frequency 636 of the FMCW signal 608, S may represent a slope 634 of the FMCW signal 320, and ¢Tx may represent a phase of the transmitting device 602.

As illustrated in FIG. 6, the FMCW signal 608 may be associated with a waveform signal transmitted via one or more symbols 632 of the OFDM channel 606 in the time domain and a bandwidth 628 (e.g., BW) of the OFDM channel 606 in the frequency domain. The bandwidth 628 may include one or more resource blocks 630 in the frequency domain. In some examples, each resource block 630 may include a set of resource elements in the frequency domain. The OFDM channel 606 may include multiple symbols 632 in the time domain. A duration or length of each symbol 632 may correspond to a length of an OFDM symbol, or a length of an OFDM symbol and a respective cyclic prefix duration, or a partial length of an OFDM symbol, or a partial length of an OFDM symbol and a respective cyclic prefix duration, or some other length longer than the length of the OFDM symbol and the length of the OFDM symbol and cyclic prefix duration, or some other symbol duration, or any combination thereof. The FMCW signal 608 may span frequencies between the starting frequency 636 and a sum of the starting frequency 636 and the bandwidth 628 (e.g., {f_{c}, f_{c}+BW}). The slope 634 of the FMCW signal 608 may correspond to a quotient of the bandwidth 628 and a duration of the symbol 632 via which the FMCW signal 608 is transmitted, as shown by Equation 2 below.

$$S = \frac{BW}{{T}_{sym}} = \frac{{N}_{RE} \cdot Δ f}{{T}_{sym}} = {N}_{RE} \cdot Δ f \cdot Δ f \qquad ( Equation 2 )$$

In the example of Equation 2, T_{sym} may represent the duration of the symbol 632, N_{RE} may represent a quantity of resource elements in the bandwidth 628, and Δf may represent a subcarrier spacing (SCS). In this example, the slope may be calculated based on a symbol duration that corresponds to a length of an OFDM symbol. For example, the duration of the symbol 632 may be an inverse of an SCS

$$( e . g . , {T}_{sym} = \frac{1}{Δ f} ) .$$

The radio frequency FMCW signal 612 that is received by the receiving device 604 via the OFDM channel 606 in response to the FMCW signal 608 transmitted by the transmitting device 602 may be represented by y_{RF,Rx} (t), shown in Equation 3 below.

$${y}_{RF , Rx} ( t ) = {\sum }_{p = 0}^{P - 1} {A}_{p} {x}_{RF , Tx} ( t - {τ}_{p} ) + n ( t ) = {\sum }_{p = 0}^{P - 1} {A}_{p} cos ( 2 π ( {f}_{c} + \frac{s}{2} ( t - {τ}_{p} ) ) ( t - {τ}_{p} ) + {ϕ}_{Tx} ) + n ( t ) \qquad ( Equation 3 )$$

In the example of Equation 3, P may represent a quantity of channel delay paths (e.g., a quantity of multi-paths) associated with the OFDM channel 606, and τₚ may represent a given channel delay with index p. That is, the received FMCW signal 612 may be sampled over various channel delays (e.g., p=0 to P−1). Ap may represent conditions of the OFDM channel 606 and n(t) may represent channel noise. In some examples, the channel noise may be associated with a relatively small value relative to the other values that define the radio frequency FMCW signal 612 that is received by the receiving device 604 in Equation 3.

As described herein, the receiving device 604 may generate an FMCW signal 616 at the receiving device. The FMCW signal 616 generated at the receiving device 604 may be referred to as a second FMCW signal or a local FMCW signal. In some examples, the receiving device 604 may generate the FMCW signal 616 in the analog domain using a VCO 614 at the receiving device 604. The receiving device 604 may generate the FMCW signal 616 at the same time as or after receiving the FMCW signal 612. The FMCW signal 616 generated by the receiving device 604 may be represented by x_{RF,Rx}(t), shown in Equation 4 below.

$${x}_{RF , Rx} ( t ) = exp ( - j ( 2 π ( {f}_{c} + \frac{s}{2} t ) t - {ϕ}_{Rx} ) ) \qquad ( Equation 4 )$$

As shown in Equation 4, the receiving device 604 may generate the FMCW signal 616 based on a set of FMCW parameters associated with the FMCW signal 608 transmitted by the transmitting device 602. The set of FMCW parameters may include, for example, the starting frequency 636 (f_{c}) of the FMCW signal 608, the slope 634 (S) of the FMCW signal 608, an initial phase of a transmitting device (e.g., φ_{Tx}), or any combination thereof. That is, the FMCW signal 616 generated by the receiving device 604 may have a same starting frequency 636 and slope 646 as the FMCW signal 608 generated by the transmitting device 602. In the example of Equation 4, @Rx may represent a phase of the receiving device 604. In some examples, the phase of the receiving device may be the same as the phase of the transmitting device (e.g., φTx=φ_{Rx}).

The FMCW signal 608 transmitted by the transmitting device 602 and the FMCW signal 616 generated at the receiving device 604 may have similar FMCW structures. For example, both signals may be wideband signals (e.g., may span a full bandwidth 628 of the OFDM channel 606), may span a duration of a symbol 632 in the OFDM channel 606, may be associated with the starting frequency 636, and may be associated with the slope 634. In some examples, the FMCW signal 608 transmitted by the transmitting device 602 may be a real signal. For example, the FMCW signal 608 may include a single stream (e.g., a cosine stream, as shown in Equation 1). The FMCW signal 616 generated by the receiving device 604 may include two streams (e.g., a sinusoidal stream and a cosine stream) for channel estimation. That is, the exponential function in the FMCW signal 616 generated by the receiving device 604 may be designed for channel estimation. In some examples, the receiving device 604 may be configured with a function for generating the FMCW signal 616 for channel estimation.

After generating the FMCW signal 616 configured for channel estimation, the receiving device 604 may generate a combined FMCW signal 620 (e.g., y_{mixed}(t)). To generate the combined FMCW signal 620, the receiving device 604 may combine the FMCW signal 612 received at the receiving device 604 with the locally generated FMCW signal 616 using a mixer 618. The mixer 618 may represent an example of one or more components (e.g., hardware, software, or both) of the receiving device 604 that are configured to combine two or more time-domain FMCW signals. In some examples, the combining may include multiplying the FMCW signals (e.g., y_{mixed}(t)=y_{RF,Rx}(t)x_{RF,Rx}(t)).

The receiving device 604 may filter the combined FMCW signal 620 using an LPF 622 at the receiving device 604. The LPF 622 may generate a combined and filtered FMCW signal (e.g., a beat frequency or beat signal) 624 (e.g., y_{mixed,LPF}(t)). The LPF 622 may represent an example of a component of the receiving device 604 that is configured to filter signals, or a function supported by the receiving device 604, or both. For example, the receiving device 604 may apply an LPF function to the combined FMCW signal 620 (e.g., y_{mixed,LPF}(t)=LPF [y_{RF,Rx}(t)x_{RF,UE}(t)]). The beat signal 624 may be represented by Equation 6 below.

$${y}_{mixed , LPF} ( t ) = {\sum }_{p = 0}^{P - 1} \frac{{A}_{p}}{2} exp ( - j ( 2 π ( {f}_{c} - \frac{s}{2} {τ}_{p} ) {τ}_{p} + {ϕ}_{Rx} - {ϕ}_{Tx} ) ) exp ( - j 2 π S {τ}_{p} \cdot t ) + \tilde{n} ( t ) \qquad ( Equation 5 )$$

Equation 5 may be simplified according to Equation 6 below.

$${y}_{mixed , LPF} ( t ) = {\sum }_{p = 0}^{P - 1} {β}_{p} exp ( - j 2 π S {τ}_{p} \cdot t ) + \tilde{n} ( t ) , where {β}_{p} = \frac{{A}_{p}}{2} exp ( - j ( 2 π {f}_{c} {τ}_{p} ) ) exp ( j ( 2 π ( \frac{s}{2} {τ}_{p} ) {τ}_{p} - {ϕ}_{Rx} + {ϕ}_{Tx} ) ) \qquad ( Equation 6 )$$

In some examples, the second exponential function in βₚ may represent a channel estimation error that may be ignored to further simplify Equation 6. For example, one half of the second exponential function of

$${β}_{p} ( e . g . , \frac{1}{2} exp ( j ( 2 π ( \frac{s}{2} {τ}_{p} ) {τ}_{p} - {ϕ}_{Rx} + {ϕ}_{Tx} ) ) )$$

may be associated with channel estimation error. However, if a value of τₚ is relatively small, the channel estimation error may also be relatively small (e.g., negligible). In some examples, the channel noise included in the radio frequency FMCW signal 612 (e.g., y_{RF,Rx}(t)) that is received by the receiving device 604 may be represented by ñ (t) after the signal is combined with the generated FMCW signal 616 and filtered using the LPF 622. As described with reference to Equation 3, the channel noise ñ (t) may be associated with a relatively small value relative to the other values that define the beat signal 624 shown in Equations 5 and 6.

After combining and filtering the FMCW signals, the receiving device 604 may perform frequency domain OFDM channel estimation using time-domain signal processing based on sampling the beat signal 624. The receiving device 604 may use an ADC 626 to sample the beat signal 624 (e.g., the beat signal) in the time domain. A sampling rate used to sample the beat signal 624 may be based on one or more parameters associated with the OFDM channel 606. For example, the sampling rate may be based on a frequency range of one or more subbands in the OFDM channel 606 (e.g., the sampling rate,

$$\frac{1}{{T}_{s}} ,$$

may be equal to an inverse of

$${T}_{s} = \frac{1}{{F}_{s}} = \frac{{f}_{subband}}{S} ) .$$

The subband frequency range, f_{subband}, may represent a granularity at which the receiving device 604 can estimate the OFDM channel 606 in the frequency domain.

The sampling by the receiving device 604 as part of the OFDM channel estimation may produce a sampling sequence, D_{Rx}(k), which may represent a set of values associated with the OFDM channel estimation. The sampling sequence may have a granularity of f_{subband}. For example, each value of D_{Rx}(k) may represent an example of an estimated value of a respective frequency subband of the OFDM channel 606. The sampling sequence, D_{Rx}(k), is shown by Equation 7.

$${D}_{Rx} ( k ) = {\sum }_{p = 0}^{P - 1} {β}_{p} exp ( - j 2 {πτ}_{p} \cdot k \cdot \frac{S}{{F}_{s}} ) + \tilde{n} ( t ) = {\sum }_{p = 0}^{P - 1} {β}_{p} exp ( - j 2 {πτ}_{p} \cdot k \cdot {f}_{subband} ) + \tilde{n} ( t ) , k = 0 , 1 , … , K - 1 \qquad ( Equation 7 )$$

In the example of Equation 7, Fₛ may represent the sampling rate used by the receiving device 604 to estimate the OFDM channel 606. K may represent a total quantity of subbands in the OFDM channel 606, which may also correspond to a total quantity of samples in the sampling sequence. Accordingly, each value of k may represent an index of a respective subband of the total quantity of subbands. In one example, if the subband frequency range f_{subband} of the OFDM channel 606 is equal to one resource element, then the sampling sequence may include a respective sample or estimated value of each resource element in the OFDM channel 606 (e.g., per comb). In some examples, the subband frequency range f_{subband} may be any other granularity, such as a set of two or more resource elements, a resource block, or some other frequency range.

The receiving device 604 may thereby estimate the frequency domain OFDM channel 606 using time domain signal processing and with a granularity of f_{subband} based on the FMCW signal 612 received at the receiving device 604 and the FMCW signal 616 generated by the receiving device 604. The described FMCW-based OFDM channel estimation techniques may be performed by the receiving device 604 in the time domain using time domain signal processing. That is, the receiving device 604 may refrain from applying FFT or other frequency transforms when using the FMCW signals to estimate the frequency domain OFDM channel 606. Additionally, or alternatively, the receiving device 604 may estimate the frequency domain OFDM channel 606 using both wideband radio frequency processing and narrowband radio frequency processing. For example, the FMCW signal 612 received at the receiving device 604 may be a wideband signal in the radio frequency, and after the LPF 622, the beat signal 624 may be a narrowband signal for baseband processing.

With FMCW-based channel estimation, a relatively low-speed ADC may be used to sample the beat signal over a wide range (e.g., from several GHz or 100s MHz, to 10s of MHz, or even less than 10 MHz). FMCW-based synchronization signals may also result in a relatively low peak to average power ratio (PAPR), facilitating low complexity full duplex sensing. FMCW-based channel estimation may have various use cases, for example, in wide (and ultra-wide) system bandwidth (e.g., 400 MHz˜8 GHz for FR3, 6 GHz, and sub THz). FMCW-based approaches may allow UEs with relative limited capability, such as mid-tier (e.g., Internet of Things/IoT) devices that do not support full system bandwidth (e.g., 20 MHz, 100 MHz, 400 MHz, 1 GHZ, etc.) to perform channel estimation over a full system bandwidth using narrowband processing capability. Moreover, by using an FMCW-based light SSB (PSS) waveform, the UE can scan multiple sync raster points at a time, with relatively low complexity. Moreover, FMCW spreading enables distinction of the light SSB (PSS) from data during scanning.

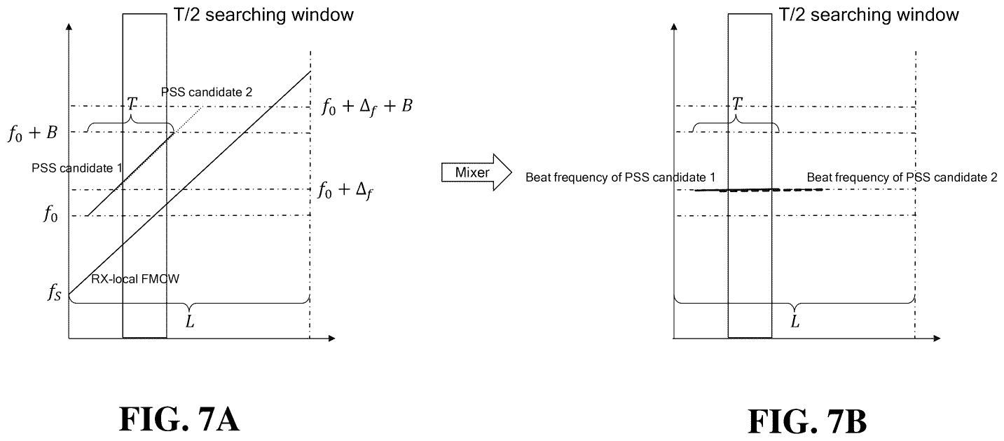

One potential issue with using an FMCW waveform is the potential for timing and frequency offset ambiguity. In other words, in some cases, a frequency offset (e.g., due to oscillator offset) and timing offset may not be distinguishable at the detector output at the receiver. This potential for ambiguity may be understood by considering the example of FMCW waveforms for two PSS candidates, PSS candidate 1 and PSS candidate 2, shown in diagram 1000 of FIG. 7A. As illustrated in diagram 1050 of FIG. 7B, the beat frequency of PSS candidate 1 and of PSS candidate 2 may appear to be the same within a (T/2) searching window. This ambiguity may make the UE unable to determine the frequency offset and time offset relative to the receiver-local FMCW, which makes the frequency/time synchronization coarse. As a result, precise frequency estimation and timing estimation may need to rely on another type of waveform, such as an SSS using a cyclic prefix orthogonal frequency division multiplexing (CP-OFDM) waveform.

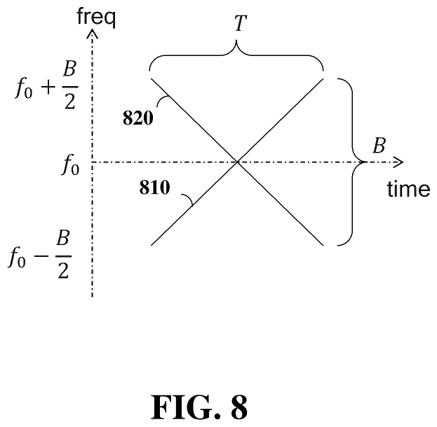

To resolve or clarify the ambiguity, other FMCW-based synchronization signal designs may be utilized. FIG. 8 is a diagram illustrating an example of an X-shaped FMCW-based synchronization signal (e.g., PSS) design. In the example shown in FIG. 8, an X-shaped FMCW-based PSS may be formed using a first FMCW waveform 810 with an associated frequency that increases (ramps up from

$${f}_{0} - \frac{B}{2} to {f}_{0} + \frac{B}{2} )$$

linearly in time (over a period T) and a second FMCW waveform 820 with an associated frequency that decreases (ramps down from

$${f}_{0} - \frac{B}{2} to {f}_{0} - \frac{B}{2} )$$

linearly in time (over T). Thus, the first FMCW waveform 810 has a slope of B/T, while the second FMCW waveform 820 has a slope of −B/T.

As illustrated, by using the same up-sweep ramp and down-sweep ramp, the first and second FMCW waveforms 810 and 820 form an X shape. A center of the X shape may be aligned with f₀, which corresponds to a synchronization (sync) raster point for a corresponding synchronization signal (e.g., PSS) formed thereby. In some cases, an OFDM architecture, as shown in FIG. 6, may be used to generate the FMCW waveform(s) for the PSS.

Since an FMCW signal is a waveform with constant envelope, the peak-to-average-power ratio (PAPR) is always 0 dB. For example, the up-ramp FMCW signal is:

$$exp ( j 2 π ( {f}_{c} + \frac{s}{2} t ) t ) ,$$

whereas the down-ramp FMCW signal is:

$$exp ( j 2 π ( {f}_{c} + BW - \frac{s}{2} t ) t ) .$$

However, the X FMCW signal increases the PAPR to at most 3 dB, as indicated by the composite X FMCW signal:

$$X FMCW : exp ( j 2 π ( {f}_{c} + \frac{s}{2} t ) t ) + exp ( j 2 π ( {f}_{c} + BW - \frac{s}{2} t ) t ) \qquad ( Equation 8 )$$

In addition, the effective signal-to-noise ratio (SNR) for the up-ramp FMCW signal and/or the down-ramp FMCW signal is reduced by half due to the 3 dB power loss. This results from the fact that half of the power is allocated to the up-ramp FMCW signal and the other half of the power is allocated to the down-ramp FMCW signal. Moreover, multiple cell differentiation may be impacted if adjacent cells transmit the same X FMCW signal. For example, a UE may not be able to differentiate the X FMCW signal sent from different neighboring cells.

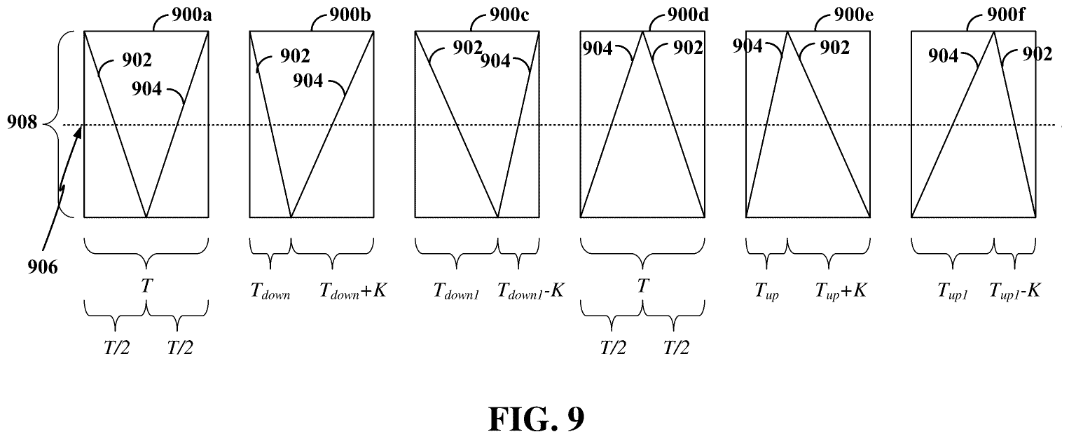

FIG. 9 is a diagram illustrating an example of a V-shaped FMCW synchronization signal design according to some aspects. The V-shaped FMCW design maintains the PACP of 0 dB and increases the SNR in comparison to the X-shaped FMCW design shown in FIG. 8. The V-shaped FMCW design includes an FMCW waveform (e.g., FMCW waveform 900a) including a first FMCW signal 902 (e.g., a down or down-sweep FMCW signal) having a linearly decreasing slope and a second FMCW signal 904 (e.g., an up or up-sweep FMCW signal) having a linearly increasing slope. For example, the first FMCW signal 902 has an associated frequency that decreases (ramps down) linearly in time and the second FMCW signal 904 has an associated frequency that increases (ramps up) linearly in time. The first FMCW signal 902 is concatenated in time with the second FMCW signal 904. In some examples, the V-shaped FMCW design may use an OFDM architecture to generate the FMCW waveform (e.g., waveform 900a).

In some examples, as shown in FIG. 9, each of the first FMCW signal 902 and the second FMCW signal 904 may have a same bandwidth (B) 908 with a center frequency f₀ corresponding to a synchronization raster 906 for a corresponding synchronization signal (e.g., PSS) formed thereby. For example, the down FMCW signal 902 may down-sweep from

$${f}_{0} - \frac{B}{2} to {f}_{0} - \frac{B}{2}$$

and the up FMCW signal 904 may up-sweep from

$${f}_{0} - \frac{B}{2}$$

to

$${f}_{0} + \frac{B}{2}$$

In some examples, as indicated by the FMCW waveform 900a, the down-sweep ramp of the down FMCW signal 902 may be the same as the up-sweep ramp of the up FMCW signal 904. Thus, each of the first FMCW signal 902 and the second FMCW signal 904 may have not only the same bandwidth (B), but also the same time-sweeping duration and the same absolute slope. For example, the total time duration for down-sweeping and up-sweeping may be represented as T, with each of the down-sweep time duration and the up-sweep time duration corresponding to T/2 and the absolute slope of each of the first and second FMCW waveforms 902 and 904 corresponding to B/(T/2) (e.g., the slope of the down FMCW waveform 902 is −B/(T/2) and the slope of the up FMCW waveform 904 is B/(T/2)). In some examples, the total time duration (T) may correspond to a single (1) OFDM symbol length.

In other examples, the down-sweep ramp of the down FMCW signal 902 may be different than the up-sweep ramp of the up FMCW signal 904, as indicated by FMCW waveforms 900b and 900c. In each of the FMCW waveforms 900b and 900c, the bandwidth (B) remains the same between the down FMCW signal 902 and the up FMCW signal 904. However, the time-sweeping duration differs between the down FMCW signal 902 and the up FMCW signal 904, and as a result, the absolute slope of each of the down FMCW signal 902 and the up FMCW signal 904 differs. For example, in the FMCW waveform 900b, the down FMCW signal 902 has a time-sweeping duration of T_{down} with a slope of −B/(T_{down}) and the up FMCW signal 904 has a time-sweeping duration of T_{down}+K, where K is an integer, with a slope of B/(T_{down}+K). In an example, the down-sweeping time duration T_{down} may correspond to one OFDM symbol length and the up-sweeping time duration T_{down}+K may correspond to an integer multiple of the OFDM symbol length. Similarly, in the FMCW waveform 900c, the down FMCW signal 902 has a time-sweeping duration of T_{down1} with a slope of −B/(T_{down1}) and the up FMCW signal 904 has a time-sweeping duration of T_{down1}−K, where K is an integer, with a slope of B/(T_{down1}−K). In an example, the down-sweeping time duration T_{down1} may correspond to one OFDM symbol length and the up-sweeping time duration T_{down1}−K may correspond to an integer fraction of the OFDM symbol length.

In each of the FMCW waveforms 900a, 900b, and 900c, the V-shaped FMCW waveform includes a down FMCW signal 902 followed by an up FMCW signal 904, where the up FMCW signal 904 is concatenated in time with the down FMCW signal 902. In other examples, an inverse V-shaped FMCW waveform (e.g., waveform 900d) may be generated using an up FMCW signal 904 followed by a down FMCW signal 902, where the down FMCW signal 902 is concatenated in time with the up FMCW signal 904. As indicated by the inverse V-shaped FMCW waveform 900d, the up-sweep ramp of the up FMCW signal 904 may be the same as the down-sweep ramp of the down FMCW signal 902. Thus, the up FMCW signal 904 may have the same bandwidth (B) and time duration (T/2) as the down FMCW signal 902. For example, the total time duration (T) may correspond to one OFDM symbol length, with each of the up FMCW signal 904 and the down FMCW signal having a time duration of ½ OFDM symbol length. Thus, each of the up FMCW signal 904 and the down FMCW signal 902 may have the same absolute slope value.

In other examples, as shown in the inverse FMCW waveforms 900e and 900f, the up-sweep ramp of the up FMCW signal 904 may be different than the down-sweep ramp of the down FMCW signal 902. For example, the bandwidth may remain the same, but the time-sweeping duration may differ between the up FMCW signal 904 and the down FMCW signal 902 in the inverse FMCW waveforms 900e and 900f. As a result, the absolute slope values of each of the up FMCW signal 904 and the down FMCW signal 902 may differ. For example, in the FMCW waveform 900e, the up FMCW signal 904 has a time-sweeping duration of Tᵤₚ with a slope of B/(Tᵤₚ) and the down FMCW signal 902 has a time-sweeping duration of Tᵤₚ+K, where K is an integer, with a slope of −B/(Tᵤₚ+K). In an example, the up-sweeping time duration Tᵤₚ may correspond to one OFDM symbol length and the up-sweeping time duration Tᵤₚ+K may correspond to an integer multiple of the OFDM symbol length. Similarly, in the FMCW waveform 900f, the up FMCW signal 904 has a time-sweeping duration of Tᵤₚ₁ with a slope of B/(Tᵤₚ₁) and the up FMCW signal 904 has a time-sweeping duration of Tᵤₚ₁−K, where K is an integer, with a slope of −B/(Tᵤₚ₁−K). In an example, the down-sweeping time duration Tᵤₚ₁ may correspond to one OFDM symbol length and the up-sweeping time duration Tᵤₚ₁−K may correspond to an integer fraction of the OFDM symbol length.

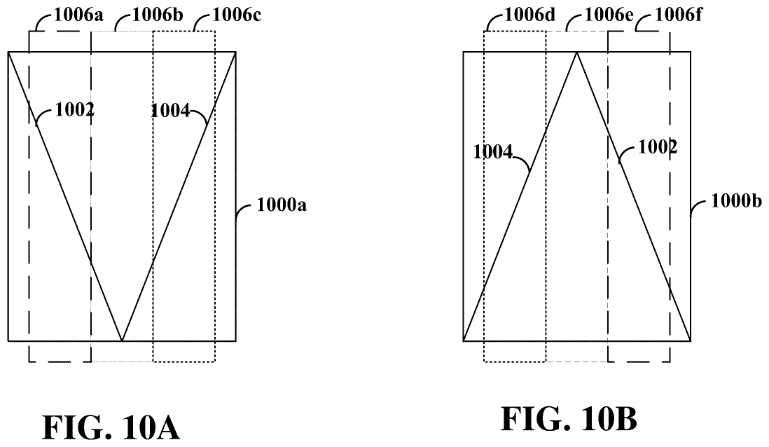

FIGS. 10A and 10B are diagrams illustrating search windows for V-shaped FMCW synchronization signals according to some aspects. For a V-shaped FMCW waveform 1000a, as shown in FIG. 10A, a receiver including a V-shaped FMCW-based PSS detector may apply a locally generated down-sweep FMCW signal to samples received in each of a plurality of search windows (e.g., search window 1006a) to locate the down FMCW signal 1002. Because the UE does not know where the actual FMCW for each frequency raster point is located, the UE may perform a receive sweep across the search windows, monitoring for the down FMCW among a set of hypotheses FMCWs. The hypothesis FMCWs may be located within a time period corresponding to a portion of the receive sweep. Based on the mixing of the received signal (e.g., based on the receive sweep) and the generated local FMCW, a beat frequency may be generated upon detection of the down FMCW signal 1002. Once the beat frequency (beat signal) is detected, the FMCW-based PSS detector may apply a locally generated up-sweep FMCW signal to samples received in the next one or two search windows 1006b and 1006c to locate the up FMCW signal 1004 and obtain the beat frequency for the up FMCW signal.

Similarly, for an inverse V-shaped FMCW waveform 1000b, as shown in FIG. 10B, a receiver including a V-shaped FMCW-based PSS detector may apply a locally generated up-sweep FMCW signal to samples received in each of a plurality of search windows (e.g., search window 1006d) to locate the up FMCW signal 1004. Once the beat frequency (beat signal) is detected, the FMCW-based PSS detector may apply a locally generated up-sweep FMCW signal to samples received in the next one or two search windows 1006e and 1006f to locate the down FMCW signal 1002 and obtain the beat frequency for the down FMCW signal.

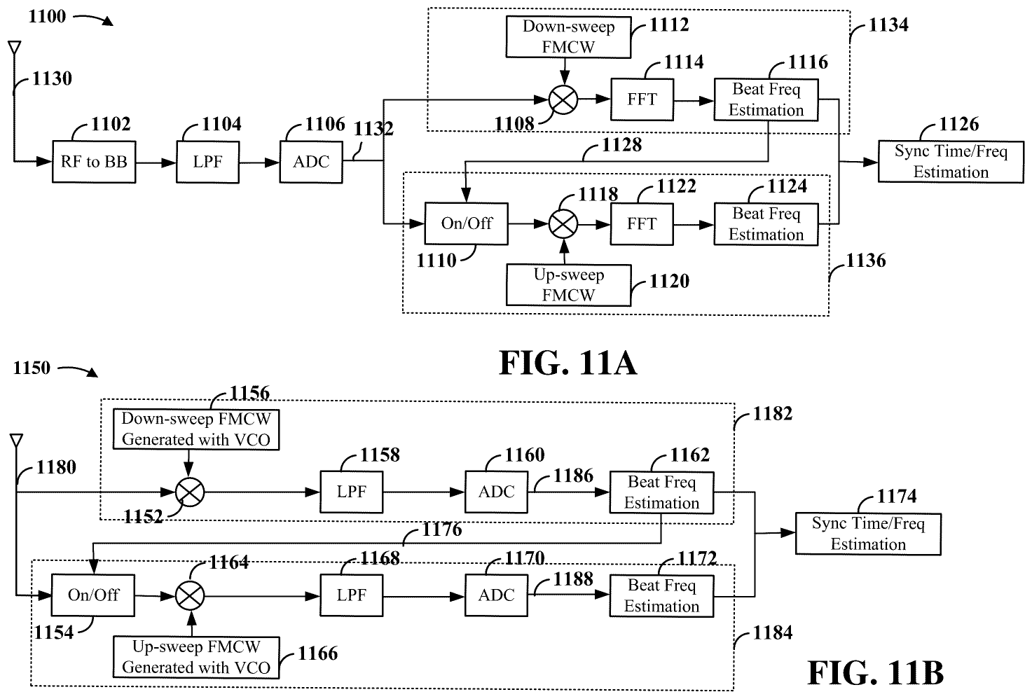

FIGS. 11A and 11B are diagrams illustrating examples of receiver architectures for V-shaped FMCW-based PSS detection according to some aspects. FIG. 11A illustrates an example of a receiving device 1100 configured to generate a beat frequency in the digital domain. In the receiving device 1100 shown in FIG. 11A, a received FMCW waveform 1130 (e.g., a V-shaped FMCW waveform including a down FMCW signal concatenated in time with an up FMCW signal) is converted from radio frequency (RF) to baseband (BB) by an RF to BB block 1102 (e.g., a mixer and VCO). The analog baseband signal is then filtered by a low pass filter (LPF) 1104 to produce a filtered analog signal, which is converted from the analog domain to the digital domain by an analog-to-digital converter (ADC) 1106 to produce a digital FMCW signal 1132.

The receiving device 1100 may further generate a local down-sweep FMCW signal 1112 in the digital domain along a first digital signal path 1134 and a local up-sweep FMCW signal 1120 in the digital domain along a second digital signal path 1136. The receiving device 1100 may generate the digital down-sweep FMCW signal 1112 and the digital up-sweep signal 1120 at the same time as or after receiving the V-shaped FMCW-based waveform 1130. The receiving device 1100 may further include a switch (On/Off) 1110 in the second digital signal path 1136 configured to block or pass the digital FMCW signal 1132 to the second digital signal path 1136.

In examples in which the PSS is a V-shaped FMCW waveform, the switch 1110 may be configured to default to the OFF position to block the digital FMCW signal 1132 from the second digital signal path 1136. In this example, the receiving device 1100 may combine the digital down-sweep FMCW signal 1112 with the digital FMCW signal 1132 along the first signal path 1134 using a multiplier 1108 to generate a combined FMCW signal. The combined FMCW signal may be input to a Fast Fourier Transform (FFT) 1114 to convert the combined FMCW signal from the time domain to the frequency domain. The combined FMCW signal is then input to a beat frequency estimation circuit 1116 to generate a beat frequency indicating detection of the down FMCW signal in the received FMCW waveform 1130. The beat frequency may then be input to synchronization (sync) time/frequency estimation circuit 1126 configured to determine a frequency offset and a timing offset based on the beat frequency. Thus, the sync time/frequency estimation circuit 1126 may be configured to determine the frequency and timing of the down FMCW signal of the FMCW waveform.

In addition, upon detection of the beat frequency, the beat frequency estimation circuit 1116 may be configured to provide a signal 1128 to the switch 1110 to switch to the ON position with the next search window. The receiving device 1100 may then combine the digital up-sweep FMCW signal 1120 with the digital FMCW signal 1132 along the second signal path 1136 using a multiplier 1118 to generate a combined FMCW signal along the second signal path 1136. The combined FMCW signal may be input to a Fast Fourier Transform (FFT) 1122 to convert the combined FMCW signal from the time domain to the frequency domain. The combined FMCW signal is then input to a beat frequency estimation circuit 1124 along the second signal path 1136 to generate a beat frequency indicating detection of the up FMCW signal in the received FMCW waveform 1130. The beat frequency may then be input to the synchronization (sync) time/frequency estimation circuit 1126 configured to determine a frequency offset and a timing offset based on the beat frequency. In addition, the sync time/frequency estimation circuit 1126 may perform coarse synchronization (e.g., based on the PSS) based on reception of one or more FMCW bursts.

In examples in which the PSS is an inverse V-shaped FMCW waveform, the switch 1110 may be positioned along the first signal path 1134 to block the digital FMCW signal 1132 from the first signal path until detection of the up FMCW signal in the FMCW waveform 1130 along the second signal path 1136. In this example, the beat frequency estimation circuit 1124 in the second signal path 1136 may be configured to output a signal to the switch 1110 to switch to the ON position along the first signal path 1134 upon detection of the up FMCW signal in the FMCW waveform 1130.

FIG. 11B illustrates an example of a receiving device 1150 configured to generate a beat frequency in the analog domain. The receiving device 1150 is configured to receive a received FMCW waveform 1180 (e.g., a V-shaped FMCW waveform including a down FMCW signal concatenated in time with an up FMCW signal). The receiving device 1150 may further generate a local down-sweep FMCW signal 1156 in the analog domain (e.g., with a VCO) along a first signal path 1182 and a local up-sweep FMCW signal 1166 in the analog domain (e.g., with a VCO) along a second signal path 1184. The receiving device 1100 may generate the analog down-sweep FMCW signal 1156 and the analog up-sweep signal 1166 at the same time as or after receiving the V-shaped FMCW-based waveform 1180. The receiving device 1150 may further include a switch (On/Off) 1154 in the second signal path 1184 configured to block or pass the FMCW waveform 1180 to the second signal path 1184.

In examples in which the PSS is a V-shaped FMCW waveform, the switch 1154 may be configured to default to the OFF position to block the FMCW waveform 1180 from the second signal path 1184. In this example, the receiving device 1150 may combine the analog down-sweep FMCW signal 1156 with the FMCW waveform 1180 along the first signal path 1182 using a mixer 1152 to generate a combined FMCW signal. The combined FMCW signal may be input to a low pass filter (LPF) 1158 to produce a filtered combined FMCW signal. The filtered combined FMCW signal may then be converted from the analog domain to the digital domain via an analog-to-digital converter (ADC) 1160 along the first signal path 1182 to produce a first digital FMCW signal 1186. The first digital FMCW signal 1186 is then input to a beat frequency estimation circuit 1162 to generate a beat frequency indicating detection of the down FMCW signal in the received FMCW waveform 1180. The beat frequency may then be input to synchronization (sync) time/frequency estimation circuit 1174 configured to determine the frequency and timing of the down FMCW signal of the FMCW waveform 1180 (e.g., the frequency offset and a timing offset based on the beat frequency).

In addition, upon detection of the beat frequency, the beat frequency estimation circuit 1162 may be configured to provide a signal 1176 to the switch 1154 to switch to the ON position with the next search window. The receiving device 1150 may then combine the analog up-sweep FMCW signal 1166 with the FMCW waveform 1180 along the second signal path 1184 using a mixer 1164 to generate a combined FMCW signal along the second signal path 1184. The combined FMCW signal may be input to a low pass filter (LPF) 1168 to produce a filtered combined FMCW signal. The filtered combined FMCW signal may then be converted from the analog domain to the digital domain via an analog-to-digital converter (ADC) 1170 along the second signal path 1184 to produce a second digital FMCW signal 1188. The second digital FMCW signal 1188 is then input to a beat frequency estimation circuit 1172 to generate a beat frequency indicating detection of the up FMCW signal in the received FMCW waveform 1180. The beat frequency may then be input to the sync time/frequency estimation circuit 1174 to determine the frequency and timing of the up FMCW signal of the FMCW waveform 1180 (e.g., the frequency offset and a timing offset based on the beat frequency). In addition, the sync time/frequency estimation circuit 1174 may perform coarse synchronization (e.g., based on the PSS) based on reception of one or more FMCW bursts.

In examples in which the PSS is an inverse V-shaped FMCW waveform, the switch 1154 may be positioned along the first signal path 1182 to block the FMCW waveform 1180 from the first signal path until detection of the up FMCW signal in the FMCW waveform 1180 along the second signal path 1184. In this example, the beat frequency estimation circuit 1172 in the second signal path 1184 may be configured to output a signal to the switch 1154 to switch to the ON position along the first signal path 1182 upon detection of the up FMCW signal in the FMCW waveform 1180.

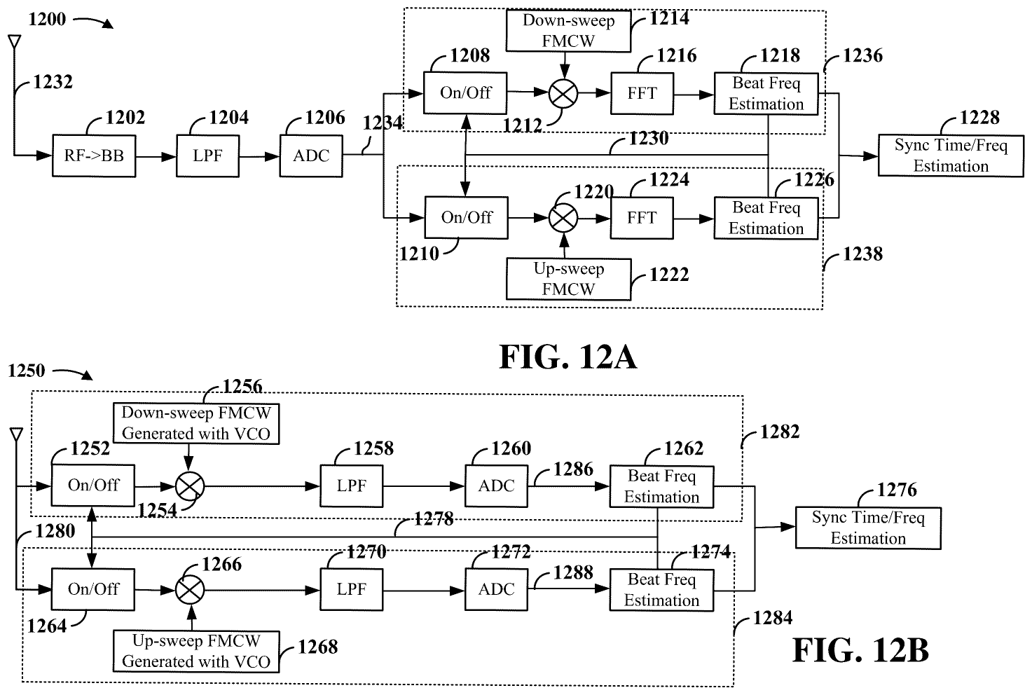

FIGS. 12A and 12B are diagrams illustrating other examples of receiver architectures for V-shaped FMCW-based PSS detection according to some aspects. FIG. 12A illustrates an example of a receiving device 1200 configured to generate a beat frequency in the digital domain. In the receiving device 1200 shown in FIG. 12A, a received FMCW waveform 1232 (e.g., a V-shaped FMCW waveform including a down FMCW signal concatenated in time with an up FMCW signal) is converted from radio frequency (RF) to baseband (BB) by an RF to BB block 1202 (e.g., a mixer and VCO). The analog baseband signal is then filtered by a low pass filter (LPF) 1204 to produce a filtered analog signal, which is converted from the analog domain to the digital domain by an analog-to-digital converter (ADC) 1206 to produce a digital FMCW signal 1234.

The receiving device 1200 may further generate a local down-sweep FMCW signal 1214 in the digital domain along a first digital signal path 1236 and a local up-sweep FMCW signal 1222 in the digital domain along a second digital signal path 1238. The receiving device 1200 may generate the digital down-sweep FMCW signal 1214 and the digital up-sweep signal 1222 at the same time as or after receiving the V-shaped FMCW-based waveform 1232. The receiving device 1200 may further include a first switch (On/Off) 1208 in the first digital signal path 1236 configured to block or pass the digital FMCW signal 1234 to the first digital signal path 1236 and a second switch (On/Off) 1210 in the second digital signal path 1238 configured to block or pass the digital FMCW signal 1234 to the second digital signal path 1238.

In examples in which the PSS is a V-shaped FMCW waveform, the first switch 1208 may be configured to default to the ON position to pass the digital FMCW signal 1234 to the first digital signal path 1236 and the second switch 1210 may be configured to default to the OFF position to block the digital FMCW signal 1234 from the second digital signal path 1238. In this example, the receiving device 1200 may combine the digital down-sweep FMCW signal 1214 with the digital FMCW signal 1234 along the first signal path 1236 using a multiplier 1212 to generate a combined FMCW signal. The combined FMCW signal may be input to a Fast Fourier Transform (FFT) 1216 to convert the combined FMCW signal from the time domain to the frequency domain. The combined FMCW signal is then input to a beat frequency estimation circuit 1218 to generate a beat frequency indicating detection of the down FMCW signal in the received FMCW waveform 1232. The beat frequency may then be input to synchronization (sync) time/frequency estimation circuit 1228 configured to determine a frequency offset and a timing offset based on the beat frequency. Thus, the sync time/frequency estimation circuit 1228 may be configured to determine the frequency and timing of the down FMCW signal of the FMCW waveform.

In addition, upon detection of the beat frequency, the beat frequency estimation circuit 1218 may be configured to provide a signal 1230 to the first switch 1208 to switch to the OFF position with the next search window and to the second switch 1210 to switch to the ON position with the next search window. The receiving device 1200 may then combine the digital up-sweep FMCW signal 1222 with the digital FMCW signal 1234 along the second signal path 1238 using a multiplier 1220 to generate a combined FMCW signal along the second signal path 1238. The combined FMCW signal may be input to a Fast Fourier Transform (FFT) 1224 to convert the combined FMCW signal from the time domain to the frequency domain. The combined FMCW signal is then input to a beat frequency estimation circuit 1226 along the second signal path 1238 to generate a beat frequency indicating detection of the up FMCW signal in the received FMCW waveform 1232. The beat frequency may then be input to the synchronization (sync) time/frequency estimation circuit 1228 configured to determine a frequency offset and a timing offset based on the beat frequency. In addition, the sync time/frequency estimation circuit 1228 may perform coarse synchronization (e.g., based on the PSS) based on reception of one or more FMCW bursts.

In examples in which the PSS is an inverse V-shaped FMCW waveform, the first switch 1208 may be set to a default OFF position to block the digital FMCW signal 1234 from the first signal path 1236, while the second switch 1210 may be set to a default ON position to pass the digital FMCW signal 1234 to the second signal path 1238. In this example, the beat frequency estimation circuit 1226 in the second signal path 1238 may be configured to output the signal 1230 to switch the first switch 1208 to the ON position along the first signal path 1236 and the second switch 1210 to the OFF position along the second signal path 1238 upon detection of the up FMCW signal in the FMCW waveform 1232.

FIG. 12B illustrates an example of a receiving device 1250 configured to generate a beat frequency in the analog domain. The receiving device 1250 is configured to receive a received FMCW waveform 1280 (e.g., a V-shaped FMCW waveform including a down FMCW signal concatenated in time with an up FMCW signal). The receiving device 1250 may further generate a local down-sweep FMCW signal 1256 in the analog domain (e.g., with a VCO) along a first signal path 1282 and a local up-sweep FMCW signal 1268 in the analog domain (e.g., with a VCO) along a second signal path 1284. The receiving device 1200 may generate the analog down-sweep FMCW signal 1256 and the analog up-sweep signal 1268 at the same time as or after receiving the V-shaped FMCW-based waveform 1280. The receiving device 1250 may further include a first switch (On/Off) 1252 in the first signal path 1282 configured to block or pass the FMCW waveform 1280 to the second signal path 1282 and a second switch (On/Off) 1264 in the second signal path 1284 configured to block or pass the FMCW waveform 1280 to the second signal path 1284.

In examples in which the PSS is a V-shaped FMCW waveform, the first switch 1252 may be configured to default to the ON position to pass the FMCW waveform 1280 to the first digital signal path 1282 and the second switch 1264 may be configured to default to the OFF position to block the FMCW waveform 1280 from the second digital signal path 1284. In this example, the receiving device 1250 may combine the analog down-sweep FMCW signal 1256 with the FMCW waveform 1280 along the first signal path 1282 using a mixer 1254 to generate a combined FMCW signal. The combined FMCW signal may be input to a low pass filter (LPF) 1258 to produce a filtered combined FMCW signal. The filtered combined FMCW signal may then be converted from the analog domain to the digital domain via an analog-to-digital converter (ADC) 1260 along the first signal path 1282 to produce a first digital FMCW signal 1286. The first digital FMCW signal 1286 is then input to a beat frequency estimation circuit 1262 to generate a beat frequency indicating detection of the down FMCW signal in the received FMCW waveform 1280. The beat frequency may then be input to synchronization (sync) time/frequency estimation circuit 1276 configured to determine the frequency and timing of the down FMCW signal of the FMCW waveform 1280 (e.g., the frequency offset and a timing offset based on the beat frequency).

In addition, upon detection of the beat frequency, the beat frequency estimation circuit 1262 may be configured to provide a signal 1278 to the first switch 1252 to switch to the OFF position with the next search window and to the second switch 1264 to switch to the ON position with the next search window. The receiving device 1250 may then combine the analog up-sweep FMCW signal 1268 with the FMCW waveform 1280 along the second signal path 1284 using a mixer 1266 to generate a combined FMCW signal along the second signal path 1284. The combined FMCW signal may be input to a low pass filter (LPF) 1270 to produce a filtered combined FMCW signal. The filtered combined FMCW signal may then be converted from the analog domain to the digital domain via an analog-to-digital converter (ADC) 1273 along the second signal path 1284 to produce a second digital FMCW signal 1288. The second digital FMCW signal 1288 is then input to a beat frequency estimation circuit 1274 to generate a beat frequency indicating detection of the up FMCW signal in the received FMCW waveform 1280. The beat frequency may then be input to the sync time/frequency estimation circuit 1276 to determine the frequency and timing of the up FMCW signal of the FMCW waveform 1280 (e.g., the frequency offset and a timing offset based on the beat frequency). In addition, the sync time/frequency estimation circuit 1276 may perform coarse synchronization (e.g., based on the PSS) based on reception of one or more FMCW bursts.

In examples in which the PSS is an inverse V-shaped FMCW waveform, the first switch 1252 may be set to a default OFF position to block the FMCW waveform 1280 from the first signal path 1282, while the second switch 1264 may be set to a default ON position to pass the FMCW waveform 1280 to the second signal path 1284. In this example, the beat frequency estimation circuit 1274 in the second signal path 1284 may be configured to output the signal 1278 to switch the first switch 1252 to the ON position along the first signal path 1282 and the second switch 1264 to the OFF position along the second signal path 1284 upon detection of the up FMCW signal in the FMCW waveform 1280.

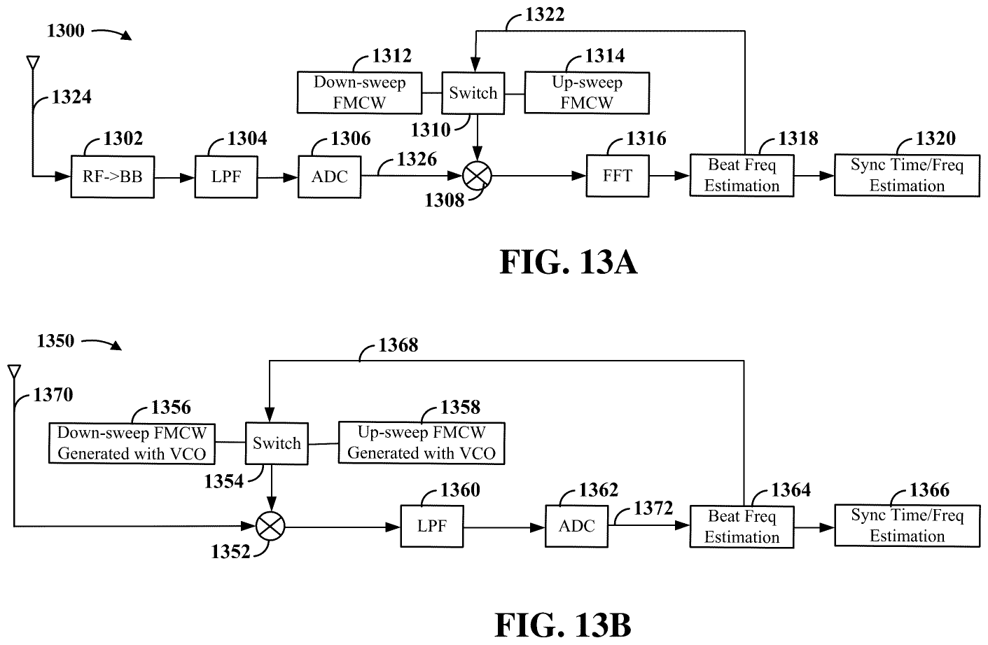

FIGS. 13A and 13B are diagrams illustrating other examples of receiver architectures for V-shaped FMCW-based PSS detection according to some aspects. FIG. 13A illustrates an example of a receiving device 1300 configured to generate a beat frequency in the digital domain. In the receiving device 1300 shown in FIG. 13A, a received FMCW waveform 1324 (e.g., a V-shaped FMCW waveform including a down FMCW signal concatenated in time with an up FMCW signal) is converted from radio frequency (RF) to baseband (BB) by an RF to BB block 1302 (e.g., a mixer and VCO). The analog baseband signal is then filtered by a low pass filter (LPF) 1304 to produce a filtered analog signal, which is converted from the analog domain to the digital domain by an analog-to-digital converter (ADC) 1306 to produce a digital FMCW signal 1326.

The receiving device 1300 may further generate a local down-sweep FMCW signal 1312 and a local up-sweep FMCW signal 1314 in the digital domain. The receiving device 1300 may generate the digital down-sweep FMCW signal 1312 and the digital up-sweep signal 1314 at the same time as or after receiving the V-shaped FMCW-based waveform 1324. The receiving device 1300 may further include a switch 1310 configured to switch between the local down-sweep FMCW signal 1314 and the local up-sweep FMCW signal 1314.

In examples in which the PSS is a V-shaped FMCW waveform, the switch 1310 may be configured to default to select the local down-sweep FMCW signal 1312. In this example, the receiving device 1300 may combine the digital down-sweep FMCW signal 1312 with the digital FMCW signal 1326 using a multiplier 1308 to generate a combined FMCW signal. The combined FMCW signal may be input to a Fast Fourier Transform (FFT) 1316 to convert the combined FMCW signal from the time domain to the frequency domain. The combined FMCW signal is then input to a beat frequency estimation circuit 1318 to generate a beat frequency indicating detection of the down FMCW signal in the received FMCW waveform 1324. The beat frequency may then be input to synchronization (sync) time/frequency estimation circuit 1320 configured to determine a frequency offset and a timing offset based on the beat frequency. Thus, the sync time/frequency estimation circuit 1320 may be configured to determine the frequency and timing of the down FMCW signal of the FMCW waveform.

In addition, upon detection of the beat frequency, the beat frequency estimation circuit 1318 may be configured to provide a signal 1322 to the switch 1310 to switch to the local up-sweep FMCW signal 1314 with the next search window. The receiving device 1300 may then combine the digital up-sweep FMCW signal 1314 with the digital FMCW signal 1326 using the multiplier 1308 to generate a combined FMCW signal that may be input to the FFT 1316 to convert the combined FMCW signal from the time domain to the frequency domain. The combined FMCW signal is then input to the beat frequency estimation circuit 1318 to generate a beat frequency indicating detection of the up FMCW signal in the received FMCW waveform 1324. The beat frequency may then be input to the synchronization (sync) time/frequency estimation circuit 1320 configured to determine a frequency offset and a timing offset based on the beat frequency. In addition, the sync time/frequency estimation circuit 1320 may perform coarse synchronization (e.g., based on the PSS) based on reception of one or more FMCW bursts.

In examples in which the PSS is an inverse V-shaped FMCW waveform, the switch 1310 may be configured to select the local up-sweep FMCW signal 1314. In this example, the beat frequency estimation circuit 1318 may be configured to output the signal 1322 to the switch 1310 to switch to the local down-sweep FMCW signal 1312 upon detection of the up FMCW signal in the FMCW waveform 1324.

FIG. 13B illustrates an example of a receiving device 1350 configured to generate a beat frequency in the analog domain. The receiving device 1350 is configured to receive a received FMCW waveform 1370 (e.g., a V-shaped FMCW waveform including a down FMCW signal concatenated in time with an up FMCW signal). The receiving device 1350 may further generate a local down-sweep FMCW signal 1356 in the analog domain (e.g., with a VCO) and a local up-sweep FMCW signal 1358 in the analog domain (e.g., with a VCO). The receiving device 1300 may generate the analog down-sweep FMCW signal 1356 and the analog up-sweep signal 1358 at the same time as or after receiving the V-shaped FMCW-based waveform 1370. The receiving device 1350 may further include a switch 1354 configured to select between the local down-sweep FMCW signal 1356 and the local up-sweep FMCW signal 1358.

In examples in which the PSS is a V-shaped FMCW waveform, the switch 1354 may be configured to default to select the down-sweep FMCW signal 1356. In this example, the receiving device 1350 may combine the analog down-sweep FMCW signal 1356 with the FMCW waveform 1370 using a mixer 1352 to generate a combined FMCW signal. The combined FMCW signal may be input to a low pass filter (LPF) 1360 to produce a filtered combined FMCW signal. The filtered combined FMCW signal may then be converted from the analog domain to the digital domain via an analog-to-digital converter (ADC) 1362 to produce a digital FMCW signal 1372. The digital FMCW signal 1372 is then input to a beat frequency estimation circuit 1364 to generate a beat frequency indicating detection of the down FMCW signal in the received FMCW waveform 1370. The beat frequency may then be input to synchronization (sync) time/frequency estimation circuit 1366 configured to determine the frequency and timing of the down FMCW signal of the FMCW waveform 1370 (e.g., the frequency offset and a timing offset based on the beat frequency).

In addition, upon detection of the beat frequency, the beat frequency estimation circuit 1364 may be configured to provide a signal 1368 to the switch 1354 to switch to the local up-sweep FMCW signal 1358 with the next search window. The receiving device 1350 may then combine the analog up-sweep FMCW signal 1358 with the FMCW waveform 1370 using the mixer 1352 to generate a combined FMCW that may be input to the LPF 1360 to produce a filtered combined FMCW signal. The filtered combined FMCW signal may then be converted from the analog domain to the digital domain via the ADC 1362 to produce the digital FMCW signal 1372. The digital FMCW signal 1372 is then input to the beat frequency estimation circuit 1364 to generate a beat frequency indicating detection of the up FMCW signal in the received FMCW waveform 1370. The beat frequency may then be input to the sync time/frequency estimation circuit 1366 to determine the frequency and timing of the up FMCW signal of the FMCW waveform 1370 (e.g., the frequency offset and a timing offset based on the beat frequency). In addition, the sync time/frequency estimation circuit 1366 may perform coarse synchronization (e.g., based on the PSS) based on reception of one or more FMCW bursts.

In examples in which the PSS is an inverse V-shaped FMCW waveform, the switch 1354 may be configured to select the local up-sweep FMCW signal 1358. In this example, the beat frequency estimation circuit 1364 may be configured to output the signal 1368 to the switch 1354 to switch to the local down-sweep FMCW signal 1356 upon detection of the up FMCW signal in the FMCW waveform 1370.

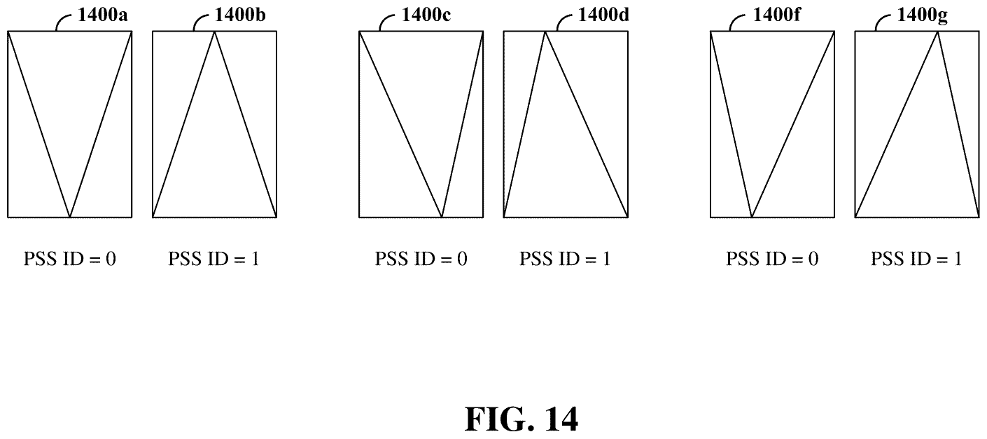

FIG. 14 is a diagram illustrating examples of multi-cell differentiation according to some aspects. As shown in FIG. 14, a V-shaped FMCW-based PSS and the corresponding inverse V-shaped FMCW-based PSS may be used to represent two different PSS IDs. For example, the V-shaped FMCW-based PSS 1400a and the corresponding inverse V-shaped FMCW-based PSS 1400b may represent different PSS IDs. Similarly, the V-shaped FMCW-based PSS 1400c and the corresponding inverse V-shaped FMCW-based PSS 1400d may represent different PSS IDs. In addition, the V-shaped FMCW-based PSS 1400e and the corresponding inverse V-shaped FMCW-based PSS 1400f may represent different PSS IDs.

To reduce the UE initial cell search complexity, the network may define the up-sweep ramp (slope) for the V-shaped FMCW-based PSS (e.g., 1400a) and the down-sweep ramp (slope) for the inverse V-shaped FMCW-based PSS (e.g., 1400b) to be the same. Similarly, the network may define the down-sweep ramp (slope) for the V-shaped FMCW-based PSS (e.g., 1400a) and the up-sweep ramp (slope) for the inverse V-shaped FMCW-based PSS (e.g., 1400b) to be the same. Therefore, the UE may be configured to generate the local up-sweep FMCW signal and the local down-sweep FMCW signal with the corresponding configured slope. In some examples, different slopes may be used for the V-shaped and inverse V-shaped FMCW-based PSS to provide more options for PSS IDs (e.g., three or more options). However, this adds to the complexity of the system.

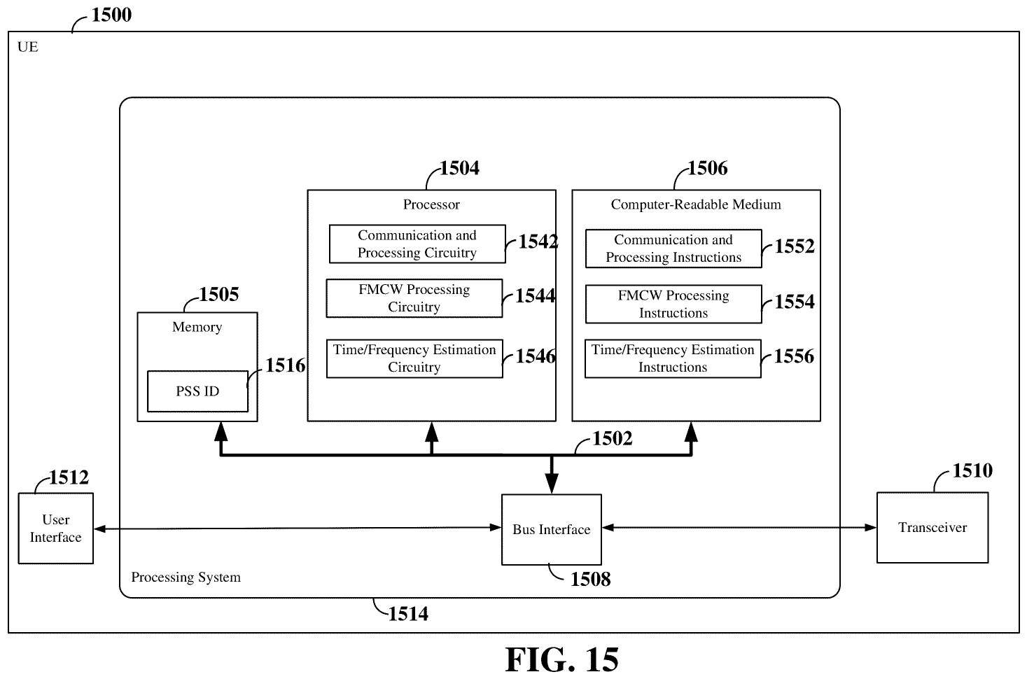

FIG. 15 is a block diagram illustrating an example of a hardware implementation for a user equipment (UE) employing a processing system 1514. For example, the UE 1500 may correspond to any of the UEs shown and described above in reference to FIGS. 1 and/or 2.

The UE 1500 may be implemented with a processing system 1514 that includes one or more processors 1504. Examples of processors 1504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1500 may be configured to perform any one or more of the functions described herein. That is, the processor 1504, as utilized in the UE 1500, may be used to implement any one or more of the processes and procedures described below.

The processor 1504 may in some instances be implemented via a baseband or modem chip and in other implementations, the processor 1504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1514 may be implemented with a bus architecture, represented generally by the bus 1502. The bus 1502 may include any number of interconnecting buses and bridges depending on the specific application of the processing system 1514 and the overall design constraints. The bus 1502 links together various circuits including one or more processors (represented generally by the processor 1504), a memory 1505, and computer-readable media (represented generally by the computer-readable medium 1506). The bus 1502 may also link various other circuits such as timing sources, peripherals, voltage regulators, and power management circuits, which are well known in the art, and therefore, will not be described any further. A bus interface 1508 provides an interface between the bus 1502 and at least one transceiver 1510. The transceiver 1510 provides a means for communicating with various other apparatus over a transmission medium (e.g., air interface).

The processor 1504 is responsible for managing the bus 1502 and general processing, including the execution of software stored on the computer-readable medium 1506. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 1504, causes the processing system 1514 to perform the various functions described below for any particular apparatus. The computer-readable medium 1506 and the memory 1505 may also be used for storing data that is utilized by the processor 1504 when executing software. For example, the memory 1505 may store one or more of a PSS ID 1516.

The computer-readable medium 1506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1506 may reside in the processing system 1514, external to the processing system 1514, or distributed across multiple entities including the processing system 1514. The computer-readable medium 1506 may be embodied in a computer program product. By way of example, a computer program product may include a computer-readable medium in packaging materials. In some examples, the computer-readable medium 1506 may be part of the memory 1505. Those skilled in the art will recognize how best to implement the described functionality presented throughout this disclosure depending on the particular application and the overall design constraints imposed on the overall system.

In some aspects of the disclosure, the processor 1504 may include circuitry configured for various functions. For example, the processor 1504 may include communication and processing circuitry 1542, configured to communicate with a network entity (e.g., an aggregated or disaggregated base station, such as a gNB or eNB). In some examples, the communication and processing circuitry 1542 may include one or more hardware components that provide the physical structure that performs processes related to wireless communication (e.g., signal reception and/or signal transmission) and signal processing (e.g., processing a received signal and/or processing a signal for transmission). In some examples, the communication and processing circuitry 1542 may include low complexity circuitry for baseband or near-baseband processing with minimal RF processing.

In some implementations where the communication involves receiving information, the communication and processing circuitry 1542 may receive a signal from a component of the UE 1500 (e.g., from the transceiver 1510 that receives the information via radio frequency signaling or some other type of signaling suitable for the applicable communication medium), process (e.g., decode) the information, and output the processed information. For example, the communication and processing circuitry 1542 may output the information to another component of the processor 1504, to the memory 1505, or to the bus interface 1508. In some examples, the communication and processing circuitry 1542 may receive one or more of signals, messages, other information, or any combination thereof. In some examples, the communication and processing circuitry 1542 may receive information via one or more channels. In some examples, the communication and processing circuitry 1542 may include functionality for a means for receiving. In some examples, the communication and processing circuitry 1542 may include functionality for a means for processing, including a means for demodulating, a means for decoding, etc.

In some implementations where the communication involves sending (e.g., transmitting) information, the communication and processing circuitry 1542 may obtain information (e.g., from another component of the processor 1504, the memory 1505, or the bus interface 1508), process (e.g., modulate, encode, etc.) the information, and output the processed information. For example, the communication and processing circuitry 1542 may output the information to the transceiver 1510 (e.g., that transmits the information via radio frequency signaling or some other type of signaling suitable for the applicable communication medium). In some examples, the communication and processing circuitry 1542 may send one or more of signals, messages, other information, or any combination thereof. In some examples, the communication and processing circuitry 1542 may send information via one or more channels. In some examples, the communication and processing circuitry 1542 may include functionality for a means for sending (e.g., a means for transmitting). In some examples, the communication and processing circuitry 1542 may include functionality for a means for generating, including a means for modulating, a means for encoding, etc.

In some examples, the communication and processing circuitry 1542 may be configured to receive or obtain, via the transceiver 1510, a synchronization signal including an FMCW waveform. The FMCW waveform may concatenate in time a first FMCW signal having a linearly decreasing slope with a second FMCW signal having a linearly increasing slope. In some examples, the synchronization signal is a PSS. In some examples, at least one of a concatenation order of the first FMCW signal and the second FMCW signal or a respective slope of the first FMCW signal and the second FMCW signal indicates a PSS identifier (ID) 1516, which may be stored, for example, in memory 1505.

In some examples, the first FMCW signal has a first duration and the second FMCW signal has a second duration. In some examples, the first duration is equal to the second duration. For example, a total duration of the first duration and the second duration may be equal to an OFDM symbol length. In some examples, the first FMCW signal and the second FMCW signal may have a same absolute slope value. In other examples, the first duration is different than the second duration. For example, the first duration may be equal to an OFDM symbol length and the second duration may be equal to an integer multiple of the first duration or an integer fraction of the first duration. As another example, the second duration may be equal to an OFDM symbol length and the first duration may be equal to an integer multiple of the second duration or an integer fraction of the second duration. In some examples, the first FMCW signal has a first absolute slope value and the second FMCW signal has a second absolute slope value different than the first absolute slope value. The communication and processing circuitry 1542 may further be configured to execute communication and processing instructions (software) 1552 stored in the computer-readable medium 1506 to implement one or more of the functions described herein.

The processor 1504 may further include FMCW processing circuitry 1544, configured to process the FMCW waveform. In some examples, the FMCW processing circuitry 1544 may correspond to the beat frequency estimation circuitry shown in FIGS. 11A-13B. In some examples, the FMCW processing circuitry 1544 may further include multipliers and/or local FMCW generation components, as shown in, for example, FIGS. 11A-13B. In some examples, the FMCW processing circuitry 1544 may operate together with mixers, VCOs, and/or other local FMCW generation components in the transceiver 1510, as shown in, for example, FIGS. 11A-13B.

The FMCW processing circuitry 1544 may be configured to apply a first locally generated FMCW signal to the FMCW waveform (e.g., the analog FMCW waveform or a digital FMCW signal) during at least a first search window, where the first locally generated FMCW signal is an up-sweep FMCW signal or a down-sweep FMCW signal. The FMCW processing circuitry 1544 may further be configured to detect a beat frequency between the first locally generated FMCW signal and the FMCW waveform. In addition, the FMCW processing circuitry 1544 may further be configured to apply a second locally generated FMCW signal during one or more additional search windows upon detection of the beat frequency, where the second locally generated FMCW signal is different than the first locally generated FMCW signal. In some examples, the first locally generated FMCW signal is the up-sweep signal and the second locally generated FMCW signal is the down-sweep signal. In other examples, the first locally generated FMCW signal is the down-sweep signal and the second locally generated FMCW signal is the up-sweep signal.

In some examples, the FMCW processing circuitry 1544 may be configured to combine the first locally generated FMCW signal with the FMCW waveform along a first signal path. In addition, the FMCW processing circuitry 1544 may be configured to turn on a switch to combine the second locally generated FMCW signal with the FMCW waveform along a second signal path in response to detecting the beat frequency. In some examples, the FMCW processing circuitry 1544 may be configured to turn on a first switch to combine the first locally generated FMCW signal with the FMCW waveform along a first signal path during the at least the first search window. In addition, the FMCW processing circuitry 1544 may be configured to turn on a second switch and turn off the first switch to combine the second locally generated FMCW signal with the FMCW waveform along a second signal path in response to detecting the beat frequency.

In some examples, the FMCW processing circuitry 1544 may be configured to combine the first locally generated FMCW signal with the FMCW waveform. In addition, the FMCW processing circuitry 1544 may be configured to switch from the first locally generated FMCW signal to the second FMCW signal to combine the second locally generated FMCW signal with the FMCW waveform. The FMCW processing circuitry 1544 may further be configured to execute FMCW processing instructions (software) 1554 stored in the computer-readable medium 1506 to implement one or more of the functions described herein.

The processor 1504 may further include time/frequency estimation circuitry 1546, configured to perform frequency and time estimation based on the FMCW waveform. For example, the time/frequency estimation circuitry 1546 may be configured to estimate a frequency offset and a timing offset based on the beat frequency. In addition, the time/frequency estimation circuitry 1546 may perform coarse synchronization (e.g., based on the PSS). The time/frequency estimation circuitry 1546 may correspond to the sync time/frequency estimation circuitry shown in FIGS. 11A-13B. The time/frequency estimation circuitry 1546 may further be configured to execute time/frequency estimation instructions (software) 1556 stored in the computer-readable medium 1506 to implement one or more of the functions described herein.

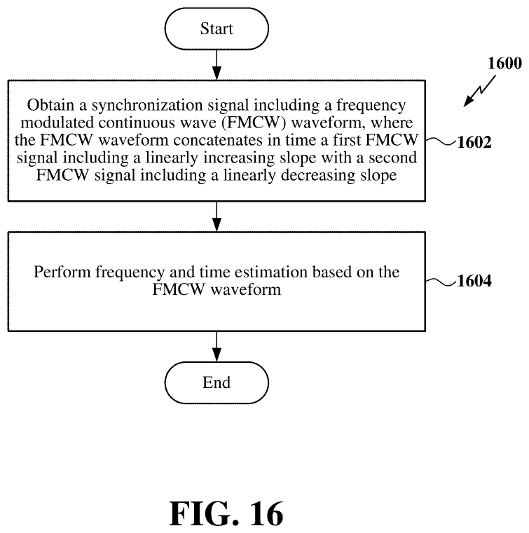

FIG. 16 is a flow chart of an exemplary process 1600 for receiving an FMCW-based synchronization signal according to some aspects. As described below, some or all illustrated features may be omitted in a particular implementation within the scope of the present disclosure, and some illustrated features may not be required for implementation of all examples. In some examples, the method may be performed by the UE 1500, as described above and illustrated in FIG. 15, by a processor or processing system, or by any suitable means for carrying out the described functions.

At block 1602, the UE may obtain synchronization signal including a frequency modulated continuous wave (FMCW) waveform, where the FMCW waveform concatenates in time a first FMCW signal including a linearly decreasing slope with a second FMCW signal including a linearly increasing slope. For example, the communication and processing circuitry 1542 in connection with the transceiver 1510, shown and described above in connection with FIG. 16, may provide a means to obtain the FMCW waveform. In some examples, the synchronization signal is a PSS. In some examples, at least one of a concatenation order of the first FMCW signal and the second FMCW signal or a respective slope of the first FMCW signal and the second FMCW signal indicates a PSS identifier (ID).

In some examples, the first FMCW signal has a first duration and the second FMCW signal has a second duration. In some examples, the first duration is equal to the second duration. For example, a total duration of the first duration and the second duration may be equal to an OFDM symbol length. In some examples, the first FMCW signal and the second FMCW signal may have a same absolute slope value. In other examples, the first duration is different than the second duration. For example, the first duration may be equal to an OFDM symbol length and the second duration may be equal to an integer multiple of the first duration or an integer fraction of the first duration. As another example, the second duration may be equal to an OFDM symbol length and the first duration may be equal to an integer multiple of the second duration or an integer fraction of the second duration. In some examples, the first FMCW signal has a first absolute slope value and the second FMCW signal has a second absolute slope value different than the first absolute slope value.

At block 1604, the UE may perform frequency and time estimation based on the FMCW waveform. For example, the time/frequency estimation circuitry 1546, shown and described above in connection with FIG. 16, may provide a means to perform the frequency and time estimation.

In some examples, the UE may further apply a first locally generated FMCW signal to the FMCW waveform (e.g., the analog FMCW waveform or a digital FMCW signal) during at least a first search window, where the first locally generated FMCW signal is an up-sweep FMCW signal or a down-sweep FMCW signal. The UE may further detect a beat frequency between the first locally generated FMCW signal and the FMCW waveform. In addition, the UE may apply a second locally generated FMCW signal during one or more additional search windows upon detection of the beat frequency, where the second locally generated FMCW signal is different than the first locally generated FMCW signal. In some examples, the first locally generated FMCW signal is the up-sweep signal and the second locally generated FMCW signal is the down-sweep signal. In other examples, the first locally generated FMCW signal is the down-sweep signal and the second locally generated FMCW signal is the up-sweep signal.

In some examples, the UE may combine the first locally generated FMCW signal with the FMCW waveform along a first signal path. In addition, the UE may turn on a switch to combine the second locally generated FMCW signal with the FMCW waveform along a second signal path in response to detecting the beat frequency. In some examples, the UE may turn on a first switch to combine the first locally generated FMCW signal with the FMCW waveform along a first signal path during the at least the first search window. In addition, the UE may turn on a second switch and turn off the first switch to combine the second locally generated FMCW signal with the FMCW waveform along a second signal path in response to detecting the beat frequency.

In some examples, the UE may combine the first locally generated FMCW signal with the FMCW waveform. In addition, the UE may switch from the first locally generated FMCW signal to the second FMCW signal to combine the second locally generated FMCW signal with the FMCW waveform.

In one configuration, the UE 1500 includes means for obtaining a synchronization signal comprising a frequency modulated continuous wave (FMCW) waveform, wherein the FMCW waveform concatenates in time a first FMCW signal comprising a linearly decreasing slope with a second FMCW signal comprising a linearly increasing slope and means for performing frequency and time estimation based on the FMCW waveform, as described in the present disclosure. In one aspect, the aforementioned means may be the processor 1504 shown in FIG. 15 configured to perform the functions recited by the aforementioned means. In another aspect, the aforementioned means may be a circuit or any apparatus configured to perform the functions recited by the aforementioned means.

Of course, in the above examples, the circuitry included in the processor 1504 is merely provided as an example, and other means for carrying out the described functions may be included within various aspects of the present disclosure, including but not limited to the instructions stored in the computer-readable storage medium 1506, or any other suitable apparatus or means described in any one of the FIGS. 1, 2, 6, 11A-13B, and/or 15 utilizing, for example, the processes and/or algorithms described herein in relation to FIG. 16.

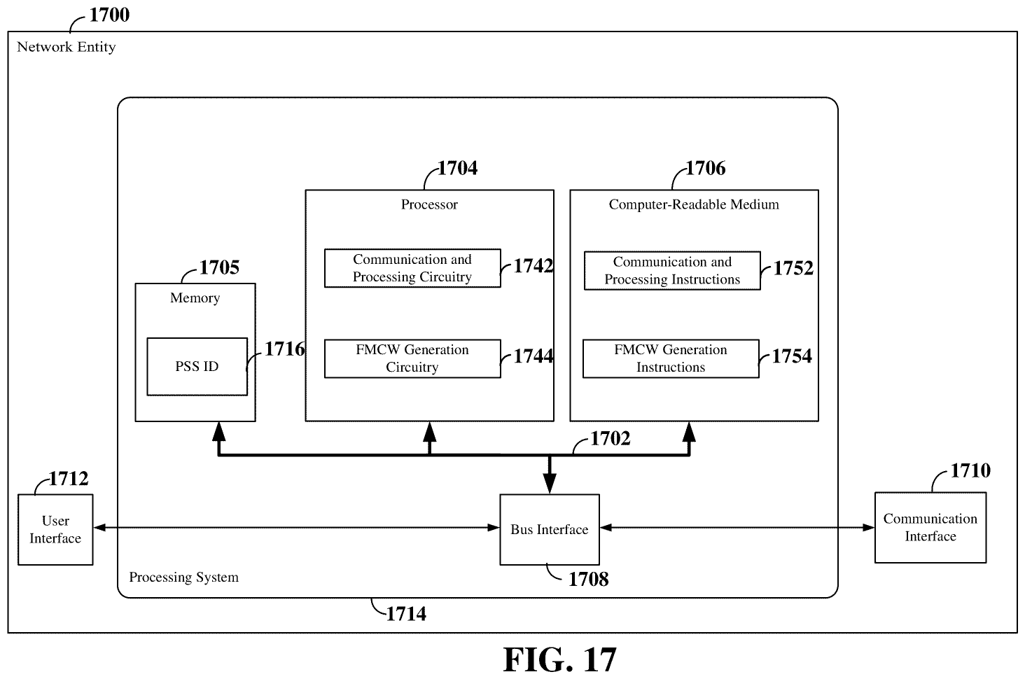

FIG. 17 is a block diagram illustrating an example of a hardware implementation for an exemplary network entity 1700 employing a processing system 1714. For example, the network entity 1700 may correspond to any of the network entities (e.g., aggregated or disaggregated base stations) shown in any one or more of FIGS. 1 and/or 2.

In accordance with various aspects of the disclosure, an element, or any portion of an element, or any combination of elements may be implemented with a processing system 1714 that includes one or more processors 1704. The processing system 1714 may be substantially the same as the processing system 1514 illustrated in FIG. 15, including a bus interface 1708, a bus 1702, memory 1705, a processor 1704, and a computer-readable medium 1706. Furthermore, the network entity 1700 may include an optional user interface 1712 and a communication interface (e.g., a transceiver and one or more antenna arrays or a network interface). The processor 1704, as utilized in a network entity 1700, may be used to implement any one or more of the processes described herein. In some examples, the memory 1705 may store one or more of a PSS ID 1716 that may be utilized by the processor 1704 when executing software.

The processor 1704 may include communication and processing circuitry 1742 configured to communicate with one or more UEs or other network entities. In some examples, the communication and processing circuitry 1742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1742 may include one or more transmit/receive chains.

In some implementations where the communication involves receiving information, the communication and processing circuitry 1742 may obtain information from a component of the network entity 1700 (e.g., from the communication interface 1710 that receives the information via radio frequency signaling or some other type of signaling suitable for the applicable communication medium), process (e.g., decode) the information, and output the processed information. For example, the communication and processing circuitry 1742 may output the information to another component of the processor 1704, to the memory 1705, or to the bus interface 1708. In some examples, the communication and processing circuitry 1742 may receive one or more of signals, messages, other information, or any combination thereof. In some examples, the communication and processing circuitry 1742 may receive information via one or more channels. In some examples, the communication and processing circuitry 1742 may include functionality for a means for receiving. In some examples, the communication and processing circuitry 1742 may include functionality for a means for processing, including a means for demodulating, a means for decoding, etc.

In some implementations where the communication involves sending (e.g., transmitting) information, the communication and processing circuitry 1742 may obtain information (e.g., from another component of the processor 1704, the memory 1705, or the bus interface 1708), process (e.g., modulate, encode, etc.) the information, and output the processed information. For example, the communication and processing circuitry 1742 may output the information to the communication interface 1710 (e.g., that transmits the information via radio frequency signaling or some other type of signaling suitable for the applicable communication medium). In some examples, the communication and processing circuitry 1742 may send one or more of signals, messages, other information, or any combination thereof. In some examples, the communication and processing circuitry 1742 may send information via one or more channels. In some examples, the communication and processing circuitry 1742 may include functionality for a means for sending (e.g., a means for transmitting). In some examples, the communication and processing circuitry 1742 may include functionality for a means for generating, including a means for modulating, a means for encoding, etc.

The communication and processing circuitry 1742 may be configured to provide a first frequency modulated continuous wave (FMCW) signal including a linearly increasing slope. The communication and processing circuitry 1742 is further configured to provide a second FMCW signal including a linearly decreasing slope. The first FMCW signal is concatenated in time with the second FMCW signal to produce a frequency modulated continuous wave (FMCW) waveform including a synchronization signal. The communication and processing circuitry 1742 may further be configured to execute communication and processing instructions (software) 1752 stored in the computer-readable medium 1706 to implement one or more of the functions described herein.

The processor 1704 may further include FMCW generation circuitry 1744, configured to generate the FMCW waveform including the first FMCW signal and the second FMCW signal. In some examples, the FMCW generation circuitry 1744 may be configured to generate the first FMCW signal with a first duration and the second FMCW signal with a second duration. In some examples, the first duration is equal to the second duration. For example, a total duration of the first duration and the second duration may be equal to an OFDM symbol length. In some examples, the first FMCW signal and the second FMCW signal may have a same absolute slope.

In other examples, the first duration is different than the second duration. For example, the first duration may be equal to an OFDM symbol length and the second duration may be equal to an integer multiple of the first duration or an integer fraction of the first duration. As another example, the second duration may be equal to an OFDM symbol length and the first duration may be equal to an integer multiple of the second duration or an integer fraction of the second duration. In some examples, the first FMCW signal has a first absolute slope value and the second FMCW signal has a second absolute slope value different than the first absolute slope value.

In some examples, the synchronization signal is a PSS. In this example, the FMCW generation circuitry 1744 may be configured to indicate a PSS ID 1716 based on at least one of a concatenation order of the first FMCW signal and the second FMCW signal or a respective slope of the first FMCW signal and the second FMCW signal. The FMCW generation circuitry 1744 may further be configured to execute FMCW generation instructions (software) 1754 stored in the computer-readable medium 1706 to implement one or more of the functions described herein.

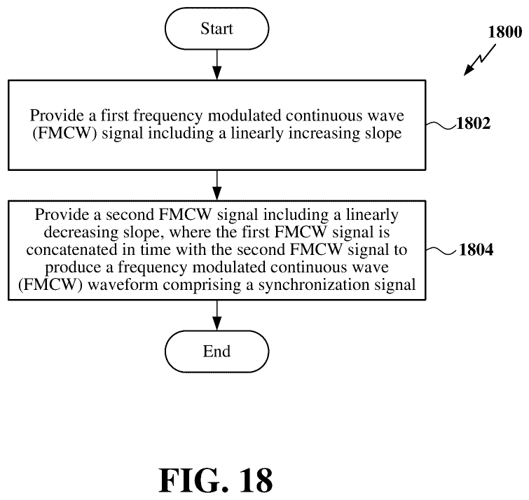

FIG. 18 is a flow chart of an exemplary process 1800 for providing an FMCW-based synchronization signal according to some aspects. As described below, some or all illustrated features may be omitted in a particular implementation within the scope of the present disclosure, and some illustrated features may not be required for implementation of all examples. In some examples, the method may be performed by the network entity 1700, as described above and illustrated in FIG. 17, by a processor or processing system, or by any suitable means for carrying out the described functions.

At block 1802, the network entity may provide a first frequency modulated continuous wave (FMCW) signal including a linearly increasing slope. For example, the communication and processing circuitry 1742 together with the communication interface 1710, shown and described above in connection with FIG. 17, may provide a means to provide the first FMCW signal.

At block 1804, the network entity may provide a second FMCW signal including a linearly decreasing slope. The first FMCW signal is concatenated in time with the second FMCW signal to produce a frequency modulated continuous wave (FMCW) waveform including a synchronization signal. For example, the communication and processing circuitry 1742 together with the communication interface 1710, shown and described above in connection with FIG. 17, may provide a means to provide the second FMCW signal.

In some examples, the network entity may generate the first FMCW signal with a first duration and the second FMCW signal with a second duration. In some examples, the first duration is equal to the second duration. For example, a total duration of the first duration and the second duration may be equal to an OFDM symbol length. In some examples, the first FMCW signal and the second FMCW signal may have a same absolute slope.

In other examples, the first duration is different than the second duration. For example, the first duration may be equal to an OFDM symbol length and the second duration may be equal to an integer multiple of the first duration or an integer fraction of the first duration. As another example, the second duration may be equal to an OFDM symbol length and the first duration may be equal to an integer multiple of the second duration or an integer fraction of the second duration. In some examples, the first FMCW signal has a first absolute slope value and the second FMCW signal has a second absolute slope value different than the first absolute slope value.

In some examples, the synchronization signal is a PSS. In this example, the network entity may indicate a PSS ID based on at least one of a concatenation order of the first FMCW signal and the second FMCW signal or a respective slope of the first FMCW signal and the second FMCW signal.

In one configuration, the network entity 1700 includes means for providing a first frequency modulated continuous wave (FMCW) signal comprising a linearly increasing slope and means for providing a second FMCW signal comprising a linearly decreasing slope, wherein the first FMCW signal is concatenated in time with the second FMCW signal to produce a frequency modulated continuous wave (FMCW) waveform comprising a synchronization signal, as described in the present disclosure. In one aspect, the aforementioned means may be the processor 1704 shown in FIG. 17 configured to perform the functions recited by the aforementioned means. In another aspect, the aforementioned means may be a circuit or any apparatus configured to perform the functions recited by the aforementioned means.

Of course, in the above examples, the circuitry included in the processor 1704 is merely provided as an example, and other means for carrying out the described functions may be included within various aspects of the present disclosure, including but not limited to the instructions stored in the computer-readable storage medium 1706, or any other suitable apparatus or means described in any one of the FIGS. 1 and/or 2 utilizing, for example, the processes and/or algorithms described herein in relation to FIG. 18.

The processes shown in FIGS. 16 and 18 may include additional aspects, such as any single aspect or any combination of aspects described below and/or in connection with one or more other processes described elsewhere herein.

Aspect 1: A method operable at a user equipment (UE), the method comprising: obtaining a synchronization signal comprising a frequency modulated continuous wave (FMCW) waveform, wherein the FMCW waveform concatenates in time a first FMCW signal comprising a linearly decreasing slope with a second FMCW signal comprising a linearly increasing slope; and performing frequency and time estimation based on the FMCW waveform.

Aspect 2: The method of aspect 1, wherein the first FMCW signal comprises a first duration and the second FMCW signal comprises a second duration.

Aspect 3: The method of aspect 2, wherein the first duration is equal to the second duration.

Aspect 4: The method of aspect 3, wherein a total duration of the first duration and the second duration is equal to an orthogonal frequency division multiplexing (OFDM) symbol length.

Aspect 5: The method of aspect 3 or 4, wherein the first FMCW signal and the second FMCW signal comprise a same absolute slope value.

Aspect 6: The method of aspect 2, wherein the first duration is different than the second duration.

Aspect 7: The method of aspect 6, wherein: the first duration is equal to an OFDM symbol length and the second duration is equal to an integer multiple of the first duration or an integer fraction of the first duration, or the second duration is equal to an OFDM symbol length and the first duration is equal to an integer multiple of the second duration or an integer fraction of the second duration.

Aspect 8: The method of aspect 6 or 7, wherein the first FMCW signal comprises a first absolute slope value and the second FMCW signal comprises a second absolute slope value different than the first absolute slope value.

Aspect 9: The method of any of aspects 1 through 8, further comprising: applying a first locally generated FMCW signal to the FMCW waveform during at least a first search window, wherein the first locally generated FMCW signal comprises an up-sweep FMCW signal or a down-sweep FMCW signal; detecting a beat frequency between the first locally generated FMCW signal and the FMCW waveform; and applying a second locally generated FMCW signal to the FMCW waveform during one or more additional search windows upon detection of the beat frequency, wherein the second locally generated FMCW signal is different than the first locally generated FMCW signal.

Aspect 10: The method of aspect 9, wherein the first locally generated FMCW signal is the up-sweep FMCW signal and the second locally generated FMCW signal is the down-sweep FMCW signal.

Aspect 11: The method of aspect 9, wherein the first locally generated FMCW signal is the down-sweep FMCW signal and the second locally generated FMCW signal is the up-sweep FMCW signal.

Aspect 12: The method of any of aspects 9 through 11, further comprising: combining the first locally generated FMCW signal with the FMCW waveform along a first signal path; and turning on a switch to combine the second locally generated FMCW signal with the FMCW waveform along a second signal path in response to detecting the beat frequency.

Aspect 13: The method of any of aspects 9 through 11, further comprising: turning on a first switch to combine the first locally generated FMCW signal with the FMCW waveform along a first signal path during the at least the first search window; and turning on a second switch and turning off the first switch to combine the second locally generated FMCW signal with the FMCW waveform along a second signal path in response to detecting the beat frequency.

Aspect 14: The method of any of aspects 9 through 11, further comprising: combining the first locally generated FMCW signal with the FMCW waveform; and switching from the first locally generated FMCW signal to the second locally generated FMCW signal to combine the second locally generated FMCW signal with the FMCW waveform.

Aspect 15: The method of any of aspects 1 through 14, wherein the synchronization signal is a primary synchronization signal (PSS).

Aspect 16: The method of aspect 15, wherein at least one of a concatenation order of the first FMCW signal and the second FMCW signal or a respective slope of the first FMCW signal and the second FMCW signal indicate a PSS identifier.

Aspect 17: An apparatus operable at a user equipment (UE) comprising one or more memories and one or more processors coupled to the one or more memories, wherein the one or more processors are configured to perform a method of any of aspects 1 through 16.

Aspect 18: An apparatus comprising means for performing a method of any of aspects 1 through 16.

Aspect 19: A non-transitory computer-readable medium having stored therein instructions executable by one or more processors of a user equipment (UE) to perform a method of any one of aspects 1 through 16.

Aspect 20: A method operable at a network entity, comprising: providing a first frequency modulated continuous wave (FMCW) signal comprising a linearly increasing slope; and providing a second FMCW signal comprising a linearly decreasing slope, wherein the first FMCW signal is concatenated in time with the second FMCW signal to produce a frequency modulated continuous wave (FMCW) waveform comprising a synchronization signal.

Aspect 21: The method of aspect 20, wherein the first FMCW signal comprises a first duration and the second FMCW signal comprises a second duration.

Aspect 22: The method of aspect 21, wherein the first duration is equal to the second duration.

Aspect 23: The method of aspect 22, wherein a total duration of the first duration and the second duration is equal to an orthogonal frequency division multiplexing (OFDM) symbol length.

Aspect 24: The method of aspect 22 or 23, wherein the first FMCW signal and the second FMCW signal comprise a same absolute slope value.

Aspect 25: The method of aspect 21, wherein the first duration is different than the second duration.

Aspect 26: The method of aspect 25, wherein the first duration is equal to an OFDM symbol length and the second duration is equal to an integer multiple of the first duration or an integer fraction of the first duration, or the second duration is equal to an OFDM symbol length and the first duration is equal to an integer multiple of the second duration or an integer fraction of the second duration.

Aspect 27: The method of aspect 25 or 26, wherein the first FMCW signal comprises a first absolute slope value and the second FMCW signal comprise a second absolute slope value different than the first absolute slope value.

Aspect 28: The method of any of aspects 20 through 27, wherein the synchronization signal is a primary synchronization signal (PSS).

Aspect 29: The method of aspect 28, wherein at least one of a concatenation order of the first FMCW signal and the second FMCW signal or a respective slope of the first FMCW signal and the second FMCW signal indicate a PSS identifier.

Aspect 30: An apparatus operable at a network entity comprising one or more memories and one or more processors coupled to the one or more memories, wherein the one or more processors are configured to perform a method of any of aspects 20 through 29.

Aspect 31: An apparatus comprising means for performing a method of any of aspects 20 through 29.

Aspect 32: A non-transitory computer-readable medium having stored therein instructions executable by one or more processors of a network entity to perform a method of any one of aspects 20 through 29.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-18 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 6, 11A-13B, 15 and/or 17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus operable at a user equipment (UE), comprising:
one or more memories; and
one or more processors coupled to the one or more memories, wherein the one or more processors are configured to:
obtain a synchronization signal comprising a frequency modulated continuous wave (FMCW) waveform, wherein the FMCW waveform concatenates in time a first FMCW signal comprising a linearly decreasing slope with a second FMCW signal comprising a linearly increasing slope; and
perform frequency and time estimation based on the FMCW waveform.

2. The apparatus of claim 1, wherein the first FMCW signal comprises a first duration and the second FMCW signal comprises a second duration.

3. The apparatus of claim 2, wherein the first duration is equal to the second duration.

4. The apparatus of claim 3, wherein a total duration of the first duration and the second duration is equal to an orthogonal frequency division multiplexing (OFDM) symbol length.

5. The apparatus of claim 3, wherein the first FMCW signal and the second FMCW signal comprise a same absolute slope value.

6. The apparatus of claim 2, wherein the first duration is different than the second duration.

7. The apparatus of claim 6, wherein:
the first duration is equal to an OFDM symbol length and the second duration is equal to an integer multiple of the first duration or an integer fraction of the first duration, or
the second duration is equal to an OFDM symbol length and the first duration is equal to an integer multiple of the second duration or an integer fraction of the second duration.

8. The apparatus of claim 6, wherein the first FMCW signal comprises a first absolute slope value and the second FMCW signal comprises a second absolute slope value different than the first absolute slope value.

9. The apparatus of claim 1, wherein the one or more processors are further configured to:
apply a first locally generated FMCW signal to the FMCW waveform during at least a first search window, wherein the first locally generated FMCW signal comprises an up-sweep FMCW signal or a down-sweep FMCW signal;
detect a beat frequency between the first locally generated FMCW signal and the FMCW waveform; and
apply a second locally generated FMCW signal to the FMCW waveform during one or more additional search windows upon detection of the beat frequency, wherein the second locally generated FMCW signal is different than the first locally generated FMCW signal.

10. The apparatus of claim 9, wherein the first locally generated FMCW signal is the up-sweep FMCW signal and the second locally generated FMCW signal is the down-sweep FMCW signal.

11. The apparatus of claim 9, wherein the first locally generated FMCW signal is the down-sweep FMCW signal and the second locally generated FMCW signal is the up-sweep FMCW signal.

12. The apparatus of claim 9, wherein the one or more processors are further configured to:
combine the first locally generated FMCW signal with the FMCW waveform along a first signal path; and
turn on a switch to combine the second locally generated FMCW signal with the FMCW waveform along a second signal path in response to detecting the beat frequency.

13. The apparatus of claim 9, wherein the one or more processors are further configured to:
turn on a first switch to combine the first locally generated FMCW signal with the FMCW waveform along a first signal path during the at least the first search window; and
turn on a second switch and turn off the first switch to combine the second locally generated FMCW signal with the FMCW waveform along a second signal path in response to detecting the beat frequency.

14. The apparatus of claim 9, wherein the one or more processors are further configured to:
combine the first locally generated FMCW signal with the FMCW waveform; and
switch from the first locally generated FMCW signal to the second locally generated FMCW signal to combine the second locally generated FMCW signal with the FMCW waveform.

15. The apparatus of claim 1, wherein the synchronization signal is a primary synchronization signal (PSS).

16. The apparatus of claim 15, wherein at least one of a concatenation order of the first FMCW signal and the second FMCW signal or a respective slope of the first FMCW signal and the second FMCW signal indicate a PSS identifier.

17. A method operable at a user equipment (UE), comprising:
obtaining a synchronization signal comprising a frequency modulated continuous wave (FMCW) waveform, wherein the FMCW waveform concatenates in time a first FMCW signal comprising a linearly decreasing slope with a second FMCW signal comprising a linearly increasing slope; and
performing frequency and time estimation based on the FMCW waveform.

18. The method of claim 17, wherein:
the first FMCW signal comprises a first duration and the second FMCW signal comprises a second duration equal to or different than the first duration, and
the first FMCW signal comprises a first absolute slope value and the second FMCW signal comprises a second absolute slope value the same as or different than the first absolute slope value.

19. The method of claim 17, wherein:
the synchronization signal is a primary synchronization signal (PSS), and
at least one of a concatenation order of the first FMCW signal and the second FMCW signal or a respective slope of the first FMCW signal and the second FMCW signal indicate a PSS identifier.

20. An apparatus operable at a network entity, comprising:
one or more memories; and
one or more processors coupled to the one or more memories, wherein the one or more processors are configured to:
provide a first frequency modulated continuous wave (FMCW) signal comprising a linearly increasing slope; and
provide a second FMCW signal comprising a linearly decreasing slope, wherein the first FMCW signal is concatenated in time with the second FMCW signal to produce a frequency modulated continuous wave (FMCW) waveform comprising a synchronization signal.

21. The apparatus of claim 20, wherein the first FMCW signal comprises a first duration and the second FMCW signal comprises a second duration.

22. The apparatus of claim 21, wherein the first duration is equal to the second duration.

23. The apparatus of claim 22, wherein a total duration of the first duration and the second duration is equal to an orthogonal frequency division multiplexing (OFDM) symbol length.

24. The apparatus of claim 22, wherein the first FMCW signal and the second FMCW signal comprise a same absolute slope value.

25. The apparatus of claim 21, wherein the first duration is different than the second duration.

26. The apparatus of claim 25, wherein:
the first duration is equal to an OFDM symbol length and the second duration is equal to an integer multiple of the first duration or an integer fraction of the first duration, or
the second duration is equal to an OFDM symbol length and the first duration is equal to an integer multiple of the second duration or an integer fraction of the second duration.

27. The apparatus of claim 25, wherein the first FMCW signal comprises a first absolute slope value and the second FMCW signal comprise a second absolute slope value different than the first absolute slope value.

28. The apparatus of claim 20, wherein the synchronization signal is a primary synchronization signal (PSS).

29. The apparatus of claim 28, wherein at least one of a concatenation order of the first FMCW signal and the second FMCW signal or a respective slope of the first FMCW signal and the second FMCW signal indicate a PSS identifier.

30. A method operable at a network entity, comprising:
providing a first frequency modulated continuous wave (FMCW) signal comprising a linearly increasing slope; and
providing a second FMCW signal comprising a linearly decreasing slope, wherein the first FMCW signal is concatenated in time with the second FMCW signal to produce a frequency modulated continuous wave (FMCW) waveform comprising a synchronization signal.
